(19) United States
(12) Patent Application Publication
(10) Pub. No.: US 2009/0128612 A1
(43) Pub. Date: May 21, 2009

(54) METHOD OF MANUFACTURING COLOR FILTER, COLOR FILTER, IMAGE DISPLAY DEVICE AND ELECTRONIC APPARATUS

(75) Inventor: Junichi SANO, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/274,610

(22) Filed: Nov. 20, 2008

(30) Foreign Application Priority Data
Nov. 21, 2007 (JP) 2007-302299

(51) Int. Cl. B41J 3/407

(52) U.S. Cl. 347/106

(57) ABSTRACT

There is provided a method of manufacturing a color filter that can suppress uneven color, uneven color density and color heterogeneity from being generated at various portion of a manufactured color filter. The manufacturing method includes an ink supplying step which supplies inks having different colors into cells formed on a substrate for a color filter to be manufactured based on drawing pattern data. The manufacturing method further includes a correction data producing step comprising preparing a test substrate having cells which correspond to the respective cells of the substrate; supplying the ink into predetermined cells of the test substrate based on the drawing pattern data by supplying droplets of the ink to the predetermined cells from the nozzles of the droplet ejection head using an ink jet method; and detecting an amount of the ink supplied to each of the predetermined cells of the test substrate. The correction data is used in adjusting a number of droplets of the ink to be supplied to each cell of the substrate based on the detection result so that an amount of the ink to be supplied to the cell becomes a target amount. The correction data producing step is periodically carried out for correcting the drawing pattern data, and the ink supply step for supplying each of the inks to the corresponding cells on the substrate is then carried out using the corrected drawing pattern data to thereby manufacture the color filter. A color filter manufactured by the manufacturing method, an image display device provided with the color filter and an electronic apparatus provided with the image display device are also provided.

### CROSS-REFERENCE TO RELATED APPLICATION

This application claims priority to Japanese Patent Application No. 2007-302299 filed Nov. 21, 2007, which is hereby expressly incorporated by reference herein in its entirety.

### BACKGROUND

1. Technical Field

The present invention relates to a method of manufacturing a color filter, a color filter, an image display device and an electronic apparatus, and more particularly to a method of manufacturing a color filter, a color filter manufactured by the manufacturing method, an image display device provided with the color filter and an electronic apparatus provided with the image display device.

2. Related Art

Generally, a color filter is used in a liquid crystal display device (LCD) which can display an image composed of different colors.

A conventional color filter has been manufactured using a so called “photolithography method”. The photolithography method is carried out by the following steps. First, a material containing a coloring agent, a photosensitive resin, a functionalized monomer, a polymerization initiator and the like is prepared (composition for forming a coloring layer) for each of different colors. Next, a coating film constituted of the composition for each color is formed on a substrate.

Thereafter, each coating film is subjected to a photosensitive treatment in which light is irradiated to the coating film through a photo mask. Then, the coating film is subjected to a development treatment to obtain the color filter.

In more detail, in such a method, the color filter is manufactured according to the following steps, for example. First, a first coating film consisted of the composition for a first color (e.g. Red) is formed on substantially the entire surface of the substrate. Thereafter, parts of the first coating film which will be used as first coloring parts of the first color are cured, and then the remaining portion of the first coating film other than the cured parts thereof is removed.

Next, a second coating film consisted of the composition for a second color which is different from the first color (e.g. Blue) is formed on substantially the entire surface of the substrate in a state that the cured parts of the first color are formed on the substrate. Thereafter, parts of the second coating film which will be used as second coloring parts of the second color are cured so that the second coloring parts do not overlap with the cured parts of the first color, and then the remaining portion of the second coating film other than the cured parts thereof is removed.

Next, a third coating film consisted of the composition for a third color which is different from the first and second colors (e.g. Green) is formed on substantially the entire surface of the substrate in a state that the cured parts of the first and second colors are formed on the substrate. Thereafter, parts of the third coating film which will be used as third coloring parts of the third color are cured so that the cured parts do not overlap with the cured parts of the first and second colors, and then the remaining portion of the third coating film other than the cured parts thereof is removed. Through these steps, the color filter is manufactured.

Therefore, in the conventional method of manufacturing the color filter described above, only a part of the coating film of each color is used as the coloring parts in the obtained color filter and most of the coating film other than the coloring parts thereof is removed in the finally obtained color filter. That is, only a small part of each coating film is used for forming the color filter. This results in an increased cost for manufacturing the color filter. Further, such a method is not preferable in view of resource saving.

Recently, another method for manufacturing a color filter using an ink jet method is proposed (one example of such a method is disclosed in JP-A 2002-372613). In this method, it is easy to control ejection positions of droplets of a material for forming a coloring layer of each color (that is, an ink for forming a coloring layer). It is also possible to reduce waste of the material for forming the coloring layer of each color. Therefore, it is possible to reduce adverse effects on the environment and decrease a cost for manufacturing the color filter.

However, in the method of manufacturing the color filter disclosed in the JP-A 2002-372613, there is a problem in that it is very difficult to equalize amounts of droplets ejected from respective nozzles of a droplet ejection head into cells formed on a substrate and make them always constant because of many factors of errors. Therefore, there is a case that a total amount of ink supplied to each of the cells which constitute coloring parts is different from to each other among the cells even in the case where a number of droplets ejected into each of the cells is the same as to each other.

In color filters, it is required that coloring parts of the same color should have the same color concentration. However, if the total amount of ink supplied to each of the respective cells differs from to each other, uneven color concentration generates at various portions of the coloring parts of the same color. As a result, uneven color and uneven color density as well as color heterogeneity (irregular lightness variation) which is comprised of many strips of such uneven color or uneven color density also generate at various portions in a manufactured color filter corresponding to such coloring parts of the color filter.

Further, variations of characteristics (in particular, contrast ratio and color reproducible rage (gamut of reproducible colors)) are likely to occur among a large number of color filters manufactured using such a method. Therefore, reliability of the manufactured color filter lowers.

### SUMMARY

Accordingly, it is an object of the present invention to provide a method of manufacturing a color filter that can suppress generation of uneven color, uneven color density and color heterogeneity.

Further, it is also an object of the present invention to provide a color filter manufactured by the manufacturing method, an image display device provided with the color filter and an electronic apparatus provided with the image display device.

In order to achieve the objects, a first aspect of the present invention is directed to a method of manufacturing a color filter using a droplet ejection apparatus having droplet ejection heads each having a plurality of nozzles from which droplets of inks having different colors are ejected into cells formed on a substrate for a color filter to be manufactured by an ink jet method. The method includes an ink supplying step in which each of the inks is supplied to a plurality of corresponding cells in the cells on the substrate from the nozzles of each droplet ejection head based on drawing pattern data.

The method further comprises correction data producing step which is comprised of: preparing a test substrate having cells which correspond to the respective cells of the substrate; supplying the ink into predetermined cells of the test substrate based on the drawing pattern data by supplying droplets of the ink to be predetermined cells from the nozzles of the droplet ejection head using the ink jet method; and detecting an amount of the ink supplied to each of the predetermined cells of the test substrate.

The correction data is used in adjusting a number of droplets of the ink to be supplied to each cell of the substrate based on the detection result so that an amount of the ink to be supplied to the cell becomes a target amount. The correction data producing step is periodically carried out for correcting the drawing pattern data, and the ink supplying step for supplying each of the inks to the corresponding cells on the substrate is then carried out using the corrected drawing pattern data to thereby manufacture the color filter.

According to the method of manufacturing a color filter of the first aspect of the present invention described above, it is possible to prevent or suppress uneven color, uneven color density and color heterogeneity from being generated at various portions of a manufactured color filter.

Further, it is possible to manufacture a color filter having a required quality (high quality) with one drawing operation. Therefore, yielding of the products is improved. In addition, it is possible to reduce time and effort required for manufacturing a color filter as compared to the conventional manufacturing method where data correction, drawing operation and inspection are carried out once after drawing operation and inspection have been carried out.

Furthermore, according to the manufacturing method, it is not necessary to produce correction data each time upon manufacturing a color filter. In the manufacturing method of the present invention, once correction data is produced, it is possible to manufacture color filters using the corrected drawing pattern data during a predetermined period of time. Therefore, the manufacturing method of the present invention is advantageous in massproduction of color filters.

A second aspect of the present invention is directed to a method of manufacturing a color filter using a droplet ejection apparatus having droplet ejection heads each having a plurality of nozzles from which droplets of inks having different colors are ejected into cells formed on a substrate for a color filter to be manufactured by an ink jet method. The method includes an ink supplying step in which each of the inks is supplied to a plurality of corresponding cells in the cells of the substrate from the nozzles of each droplet ejection head based on drawing pattern data.

The method further comprises: correction data producing step which is comprised of: detecting an amount of the ink ejected from each nozzle per one ejecting operation; and estimating an amount of the ink to be supplied to each cell when the ink is supplied to the cell of the substrate by ejecting the droplets of the ink from the nozzle of the droplet ejection head by the ink jet method based on the detection result and the drawing pattern data.

The correction data is used in adjusting a number of droplets of the ink to be supplied to each cell of the substrate based on the result of the estimation so that an amount of the ink to be supplied to the cell becomes a target amount. Further, the correction data producing step is periodically carried out for correcting the drawing pattern data, and the ink supply step for supplying each of the inks to the corresponding cells on the substrate is then carried out using the corrected drawing pattern data to thereby manufacture the color filter.

According to the method of manufacturing a color filter of the second aspect of the present invention described above, it is possible to prevent or suppress uneven color, uneven color density and color heterogeneity from being generated at various portions of a manufactured color filter.

Further, it is possible to manufacture a color filter having a required quality (high quality) with one drawing operation. Therefore, yielding of the products is improved. In addition, it is possible to reduce time and effort required for manufacturing a color filter as compared to the conventional manufacturing method where data correction, drawing operation and inspection are carried out once after drawing operation and inspection have been carried out.

Furthermore, according to the manufacturing method, it is not necessary to produce correction data each time upon manufacturing a color filter. In the manufacturing method of the present invention, once correction data is produced, it is possible to manufacture color filters using the correction drawing pattern data during a predetermined period of time. Therefore, the manufacturing method of the present invention is advantageous in massproduction of color filters.

In the present invention described above, it is preferred that the predetermined cells include all of the cells, cells for a specified one color or specified more colors, or cells for a specified region.

Further, in the present invention described above, it is also preferred that the droplet ejection heads are periodically exchanged, and the correction data producing step is carried out at a time when the droplet ejection heads are exchanged.

This makes it possible to prevent or suppress uneven color, uneven color density and color heterogeneity from being generated at various portions of a manufactured color filter.

Furthermore, in the present invention described above, it is also preferred that a reset signal is periodically inputted into the droplet ejection apparatus, and the correction data is updated into new correction data each time upon the input of the reset signal.

This also makes it possible to prevent or suppress uneven color, uneven color density and color heterogeneity from being generated at various portions of a manufactured color filter.

Furthermore, in the present invention described above, it is also preferred that the correction of the drawing pattern data is carried out during the correction data producing step or after the correction data producing step.

This also makes it possible to reliably prevent or suppress uneven color, uneven color density and color heterogeneity from being generated at various portions of a manufactured color filter.

Furthermore, in the present invention described above, it is preferred that each of the droplet ejection heads includes driving elements, and each droplet ejection head is constructed so that droplets of the ink are ejected from each nozzle of the droplet ejection head when a driving voltage is applied to each driving element, wherein the method further comprises a driving voltage adjustment step which includes a step of detecting an amount of the ink ejected from each nozzle per one ejecting operation prior to the correction data producing step and a step of adjusting the driving voltage to be applied to each driving element based on the detection result so that variations of the amount of the ink ejected from each nozzle per one ejecting operation are made to be small.

This also makes it possible to reliably prevent or suppress uneven color, uneven color density and color heterogeneity from being generated at various portions of a manufactured color filter.

A third aspect of the present invention is directed to a color filter manufactured by the color filter manufacturing method described above.

This makes it possible to provide a color filter which can prevent or suppress uneven color, uneven color density and color heterogeneity from being generated at various portions of the color filter.

A fourth aspect of the present invention is directed to an image display device provided with the color filter described above.

This makes it possible to provide an image display device which can prevent or suppress uneven color, uneven color density and color heterogeneity from being generated at various portions of the image display device.

In the present invention described above, it is preferred that the image display device is a liquid crystal panel.

This makes it possible to provide a liquid crystal panel which can prevent or suppress uneven color, uneven color density and color heterogeneity from being generated at various portions of the liquid crystal panel.

A fifth aspect of the present invention is directed to an electronic apparatus provided with the image display device described above.

This makes it possible to provide an electronic apparatus which can prevent or suppress uneven color, uneven color density and color heterogeneity from being generated at various portions of the image display portion thereof.

The foregoing and other objects, features and advantages of the present invention will become more readily apparent from the following detailed description of preferred embodiments of the present invention which proceeds with reference to the accompanying drawings.

### BRIEF DESCRIPTION OF THE DRAWINGS

FIG. 1 is a cross sectional view which shows a preferred embodiment of a color filter according to the present invention.

FIG. 2 is a perspective view of a droplet ejection apparatus which can be used in manufacturing a color filter of the present invention.

FIG. 3 is a perspective view which shows a head unit of the droplet ejection apparatus shown in FIG. 2.

FIG. 4 is an illustration which shows an ink supply system used in the droplet ejection apparatus shown in FIG. 2.

FIG. 5 is a schematic plan view of the droplet ejection apparatus shown in FIG. 2 (a part thereof is omitted).

FIG. 6 is a plan view which shows a head unit of the droplet ejection apparatus shown in FIG. 2 and a substrate provided with a number of cells.

FIG. 7 is an enlarged plan view which shows a part of a nozzle surface (nozzle plate) of the droplet ejection head and cells of the substrate.

FIG. 8(a) and FIG. 8(b) are respectively a perspective cross-sectional view and a cross sectional view of the droplet ejection head of the droplet ejection apparatus shown in FIG. 2.

FIG. 9 is a block diagram of the droplet ejection apparatus shown in FIG. 2.

FIG. 10(a) is a schematic view of a head driving unit, and FIG. 10(b) is a timing chart which shows a driving signal, a selecting signal and an ejection signal for the head driving unit.

FIG. 11 is a schematic plan view which explains the positional relationship of each of the droplet ejection heads in the head unit of the droplet ejection apparatus shown in FIG. 2.

FIG. 12 (1A to 1E) is a schematic cross-sectional view which shows a method of manufacturing a color filter.

FIG. 13 is a flow chart which shows control operations of an overall system including the droplet ejection apparatus shown in FIG. 2.

FIG. 14 is a cross sectional view which shows a preferred embodiment of a liquid crystal display device.

FIG. 15 is a perspective view which shows a structure of a mobile (or note book type) personal computer which is one example of the electronic apparatus according to the present invention.

FIG. 16 is a perspective view which shows a structure of a portable phone (including a personal handy phone system) which is another example of the electronic apparatus according to the present invention.

FIG. 17 is a perspective view which shows a structure of a digital still camera which is other example of the electronic apparatus according to the present invention.

### DETAILED DESCRIPTION OF THE INVENTION

Hereinbelow, preferred embodiments of a method of manufacturing a color filter, a color filter, an image display device and an electronic apparatus according to the present invention will now be described in detail with reference to the appended drawings.

### First Embodiment

Ink for Use in Color Filter

An ink 2 for use in a color filter 1 (hereinafter, simply referred to as “ink” on occasions) according to the present invention is an ink which is used for manufacturing a color filter (forming coloring parts of the color filter). In particular, the ink 2 according to the present invention is an ink which is used for manufacturing the color filter by an ink jet method.

The ink 2 is comprised of a coloring agent, a liquid medium in which the coloring agent is dissolved or dispersed and a resin material, and the like.

Coloring Agent

In general, a color filter 1 has a large number of coloring parts 12 having different colors (that is, three colors corresponding to red (R), green (G) and blue (B), namely RGB). Generally, a coloring agent is selected depending on the colors of the coloring parts to be formed. Examples of the coloring agent to constitute the ink 2 include various pigments and various dyes.

Examples of such various pigments include: C.I. Pigment Reds 2, 3, 5, 17, 22, 23, 38, 81, 48:1, 48:2, 48:3, 48:4, 49:1, 52:1, 53:1, 57:1, 63:1, 112, 122, 144, 146, 149, 166, 170, 176, 177, 178, 179, 185, 202, 207, 209, 254, 101, 102, 105, 106, 108, and 108:1; C.I. Pigment Greens 7, 36, 15, 17, 18, 19, 26, and 50; C.I. Pigment Blues 1, 15, 15:1, 15:2, 15:3, 15:4, 15:6, 17:1, 18, 60, 27, 28, 29, 35, 36, and 80; C.I. Pigment Yellows 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, and 157; C.I. Pigment Violets 1, 3, 19, 23, 50, 14, and 16; C.I. Pigment Oranges 5, 13, 16, 36, 43, 20, 20:1, and 104; C.I. Pigment Browns 25, 7, 11, and 33; and the like.

Examples of such various dyes include an azo dye, an anthraquinone dye, a condensed polynuclear aromatic carbonyl dye, an indigoid dye, a carbonium dye, a phthalocyanine dye, a methine dye, a polymethine dye, and the like.

Examples of such various dyes include: C.I. Direct Reds 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. Acid Reds 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C.I. Reactive Reds 3, 13, 17, 19, 21, 22, 23, 24, 29, 35, 37, 40, 41, 43, 45, 49, and 55; C.I Basic Reds 12, 13, 14, 15, 18, 22, 23, 24, 25, 27, 29, 35, 36, 38, 39, 45, and 46; C.I. Direct Violets 7, 9, 47, 48, 51, 66, 90, 93, 94, 95, 98, 100, and 101; C.I. Acid Violets 5, 9, 11, 34, 43, 47, 48, 51, 75, 90, 103, and 126; C.I. Reactive Violets 1, 3, 4, 5, 6, 7, 8, 9, 16, 17, 22, 23, 24, 26, 27, 33, and 34; C.I. Basic Violets 1, 2, 3, 7, 10, 15, 16, 20, 21, 25, 27, 28, 35, 37, 39, 40, and 48; C.I. Direct Yellows 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C.I. Acid Yellows 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C.I. Reactive Yellows 2, 3, 13, 14, 15, 17, 18, 23, 24, 25, 26, 27, 29, 35, 37, 41, and 42; C.I. Basic Yellows 1, 2, 4, 11, 13, 14, 15, 19, 21, 23, 24, 25, 28, 29, 32, 36, 39, and 40; C.I. Acid Greens 16; C.I. Acid Blues 9, 45, 80, 83, 90, and 185; C.I. Basic Oranges 21 and 23; and the like.

As the coloring agent, it is possible to use powders (particles) subjected to a surface treatment such as a lyophilic treatment, wherein the powders (particles) are constituted of the coloring agent as mentioned above. In this regard, it is to be noted that the lyophilic treatment means a treatment which improves affinity to the liquid medium described later. This makes it possible to exhibit superior dispersibility and dispersion stability of the particles of the coloring agent in the ink 2.

Examples of the surface treatment to the coloring agent include a treatment which modifies the surfaces of the particles of the coloring agent with a polymer, and the like. Examples of such a polymer to be used for modifying the surfaces of the particles of the coloring agent include polymers disclosed in JP-A-8-259876, commercially available polymers or commercially available oligomers for use in dispersing various pigments, and the like.

Further, the coloring agent may be used in combination of two or more of the materials described above.

In the ink 2, the coloring agent may be dissolved or dispersed in the liquid medium described later. In the case where the coloring agent is dispersed in the liquid medium, an average particle size of the coloring agent is preferably in the range of 20 to 200 nm, and more preferably in the range of 5 to 90 nm.

This makes it possible to exhibit superior light resistance of the color filter 1 manufactured by using the ink 2. Further, it is also possible to reliably exhibit superior dispersion stability of the coloring agent in the ink 2. Furthermore, it is also possible to reliably exhibit superior color development of the coloring parts 12 in the color filter 1.

An amount of the coloring agent contained in the ink 2 is preferably in the range of 2 to 20 wt %, and more preferably in the range of 3 to 15 wt %. If the amount of the coloring agent falls within above noted range, it is possible to exhibit superior ejection characteristics (ejection stability) of the ink 2 ejected from nozzles 25 of a droplet ejection head 20. Further, it is also possible to exhibit superior durability of the manufactured color filter 1. Furthermore, it is also possible to reliably obtain appropriate color density in the manufactured color filter 1.

Liquid Medium

The liquid medium has a function of dissolving and/or dispersing the coloring agent as described above. In other words, the liquid medium serves as a solvent and/or a dispersant of the coloring agent. Generally, most of the liquid medium is removed in the process of manufacturing the color filter 1.

Examples of the liquid medium contained in the ink 2 include ester compounds, ether compounds, hydroxyketon, carbonic diester, cyclic amide compounds and the like. Among these components mentioned above, the following components are preferable. The components are: (1) ether such as condensation between polyvalent alcohols (e.g., ethylene glycol, propylene glycol, butylenes glycol, glycerin, and the like), and alkyl ether such as methyl ether, ethyl ether, butyl ether and hexyl ether, which is obtained by using polyvalent alcohol or polyvalent alcohol ether; (2) ester such as methyl ester (at least one carboxylic acid thereof is esterified) which is obtained by using polyvalent carboxylic acid (succinic acid, and glutaric acid); (3) ether or ester which is obtained by using a compound (hydroxyl acid) having at least one hydroxyl group and one carboxyl group in the molecule thereof; (4) carbonic diester having a chemical structure of a compound which is obtained by reaction of polyvalent alcohol and phosgene; and (5) ester such as formate, acetate and propionate.

Examples of compounds that can be used as the liquid medium include 2-(2-methoxy-1-methylethoxy)-1-methyl ethyl acetate, triethylene glycol dimethyl ether, triethylene glycol diacetate, diethylene glycol monoethyl ether acetate, 4-methyl-1,3-dioxolane-2-on, bis(2-butoxyethyl)ether, dimethyl glutarate, ethylene glycol di-n-butyrate, 1,3-butylene glycol diacetate, diethylene glycol monobutyl ether acetate, tetraethylene glycol dimethyl ether, 1,6-diacetoxy hexan, tripropylene glycol monomethyl ether, butoxy propanol, dipropylene glycol dimethyl ether, diethylene glycol dimethyl ether, 3-ethoxy ethyl propionate, diethylene glycol ethyl methyl ether, 3-methoxy butyl acetate, diethylene glycol diethyl ether, ethyl octanate, ethylene glycol monobutyl ether acetate, cyclohexyl acetate, diethyl succinate, ethylene glycol diacetate, propylene glycol diacetate, 4-hydroxy-4-methyl-2-pentanone, dimethyl succinate, 1-butoxy-2-propanol, diethylene glycol monoethyl ether, diethylene glycol monomethyl ether, dipropylene glycol monomethyl ether, 3-methoxy-n-butyl acetate, diacetin, dipropylene glycol n-propyl ether, polyethylene glycol monomethyl ether, butyl glycolate, ethylene glycol monohexyl ether, dipropylene glycol n-butyl ether, N-methyl-2-pyrrolidone, triethylene glycol butyl methyl ether, bis(2-propoxyethyl)ether, diethylene glycol diacetate, diethylene glycol butyl methyl ether, diethylene glycol butyl ethyl ether, diethylene glycol butyl propyl ether, diethylene glycol ethyl propyl ether, diethylene glycol methyl propyl ether, diethylene glycol propyl ether acetate, triethylene glycol methyl ether acetate, triethylene glycol ethyl ether acetate, triethylene glycol propyl ether acetate, triethylene glycol butyl ether acetate, triethylene glycol butyl ethyl ether, triethylene glycol ethyl methyl ether, triethylene glycol ethyl propyl ether, triethylene glycol methyl propyl ether, dipropylene glycol methyl ether acetate, n-nonyl alcohol, diethylene glycol monobutyl ether, triethylene glycol monomethyl ether, ethylene glycol 2-ethyl hexyl ether, triethylene glycol monoethyl ether, diethylene glycol monohexyl ether, triethylene glycol monobutyl ether, diethylene glycol mono-2-ethylhexyl ether, tripropylene glycol n-butyl ether. These compounds may be used singly or in a combination of two or more of them.

In particular, it is preferred that the liquid medium which constitutes each ink 2 for a color filter is or are one or more compound(s) selected from the group comprising bis(2-propoxyethyl)ether, 2-(2-methoxy-1-methylethoxy)-1-methyl ethyl acetate, triethylene glycol dimethyl ether, triethylene glycol diacetate, diethylene glycol monoethyl ether acetate, bis(2-butoxyethyl)ether, dimethyl glutarate, ethylene glycol di-n-butyrate, 1,3-butylene glycol diacetate, diethylene glycol monobutyl ether acetate, and tetraethylene glycol dimethyl ether. This makes it possible to effectively suppress uneven color and uneven density from being generated at various portions of a manufactured color filter. Further, it is possible to make uniformity in characteristics among manufactured color filters especially excellent.

Among the compounds mentioned above, it is particularly preferred that the liquid medium contains triethylene glycol diacetate. This is because triethylene glycol diacetate has an acetate structure having a long chain and a symmetry property, mutual intermolecular force is diffusive and week, and thus conformation change against temperature changes is particularly small and viscosity change is also particularly small. In the case where the liquid medium contains triethylene glycol diacetate, a ratio occupied by the triethylene glycol diacetate with respect to the liquid medium is preferably in the range of 30 to 70 wt %.

Further, it is also particularly preferred that the liquid medium contains tetraethylene glycol dimethyl ether. This is because tetraethylene glycol dimethyl ether has an ether structure having a long chain and a symmetry property, mutual intermolecular force is more diffusive and weaker than that of the symmetrical acetate structure, and thus conformation change against temperature changese is particularly small and viscosity change is also particularly small. In the case where the liquid medium contains tetraethylene glycol dimethyl ether, a ratio occupied by the tetraethylene glycol dimethyl ether with respect to the liquid medium is preferably in the range of 30 to 70 wt %.

The amount of the liquid medium in the ink 2 is preferably in the range of 70 to 98 wt %, and more preferably in the range of 80 to 95 wt %. If the amount of the liquid medium contained in the ink 2 is a value within the above range, it is possible to make ejection characteristic (ejection stability) of the ink 2 from the droplet ejection head especially excellent and also possible to make durability of a manufactured color filter 1 especially excellent.

In addition, this also makes it possible to effectively suppress uneven color and uneven density from being generated at various portions of a manufactured color filter 1. Further, it is also possible to make uniformity in characteristics among manufactured color filters 1 especially excellent. Furthermore, it is also possible to secure sufficient color density in manufactured color filters 1.

Dispersant

The ink 2 for use in the color filter 1 may further contain a dispersant. Even if the ink 2 contains a pigment having low dispersibility, it is possible to reliably exhibit superior dispersion stability of the pigment. As a result, it is possible to exhibit superior preservability or storage stability of the ink 2.

Examples of such a dispersant include a cationic surfactant, an anionic surfactant, a nonionic surfactant, an ampholytic surfactant, a silicone type surfactant, a fluorochemical surfactant and the like.

Examples of such surfactants include: polyoxy ethylene alkyl ether such as polyoxyethylene lauryl ether, polyoxyethylene stearyl ether, and polyoxyethylene oleyl ether; polyoxyethylene alkyl phenyl ether such as polyoxyethylene n-octyl phenyl ether, and polyoxyethylene n-nonyl phenyl ether; polyethylene glycol diester such as polyethylene glycol dilaurate, and polyethylene glycol distearate; sorbitan fatty acid ester; fatty acid modified-polyester; tertiary amine modified-polyurethane; polyethylene imine; a product such as KP (produced by Shin-Etsu Chemical Co., Ltd.), Poly-Flow (produced by KYOEISHA CHEMICAL CO., LTD.), FTOP (produced by JEMCO Inc.), MEGAFACK (produced by DIC Corporation), Flolard (produced by Sumitomo 3M Limited), AsahiGuard and Surflon (produced by ASAHI GLASS CO., LTD.), Disperbyk (produced by BYK Japan KK), Solsperse 3000, 5000, 11200, 12000, 13240, 13650, 13940, 16000, 17000, 18000, 20000, 21000, 22000, 24000SC, 24000GR (produced by LUBRIZOL JAPAN Ltd.), and Surfinol and Dynol (produced by Air Products Inc.); and the like.

An amount of the dispersant contained in the ink 2 for a color filter 1 is preferably in the range of 0.5 to 15 wt %, and more preferably in the range of 0.5 to 8 wt %.

Resin Material

Generally, a resin material (binder resin) is contained in the ink 2 for a color filter 1. Inclusion of the resin material in the ink 2 makes it possible to exhibit superior adhesion between coloring parts 12 (coloring layer) and a substrate 11 in the manufactured color filter 1. Therefore, the manufactured color filter 1 can exhibit superior durability.

The resin material may be of any kind of resin materials. Examples of such a resin material to be contained in the ink 2 include various thermoplastic resins, various thermosetting resins and the like. However, it is preferred that the resin material is an acrylic resin and an epoxy resin which are obtained by polymerizing a polyfunctional molecule.

This is because the acrylic resin and the epoxy resin have characteristics in that transparency thereof is high, hardness thereof is high and an amount of heat contraction thereof is low. Therefore, use of the acrylic resin or the epoxy resin makes it possible to exhibit superior adhesion between the coloring parts 12 and the substrate 11.

In the case where epoxy resin is used, an epoxy resin having both a silyl acetate structure (SiOCOCH₃) and an epoxy structure in the chemical structure thereof can be preferably used. Use of such an epoxy resin makes it possible to eject (discharge) droplets of the ink 2 by an ink jet method reliably. Additionally, inclusion of such an epoxy resin in the ink 2 makes it possible to exhibit superior adhesion between coloring parts 12 (coloring layer) and the substrate 11. Therefore, the manufactured color filter 1 can exhibit superior durability.

An amount of the resin material contained in the ink 2 is preferably in the range of 0.5 to 10 wt %, and more preferably in the range of 1 to 5 wt %. If the amount of the resin material falls within above noted range, it is possible to exhibit superior ejection characteristics (ejection stability) of the ink 2 ejected from the droplet ejection head 20. Further, the manufactured color filter can exhibit superior durability. Furthermore, it is also possible to reliably obtain appropriate color density in the manufactured color filter 1.

Other Components

Various other components may be contained in the ink 2 for a color filter 1, if necessary.

Examples of such other components (other additive) include: various crosslinking agents; various polymerization initiators; a dispersion auxiliary such as a blue pigment derivative which includes a copper phthalocyanine derivative and a yellow pigment derivative; a filler such as glass and alumina; a polymer such as polyvinyl alcohol, polyethylene glycol monoalkyl ether, poly fluoro alkyl acrylate; an adhesion accelerating agent such as vinyl trimethoxy silane, vinyl triethoxy silane, vinyl tris(2-methoxyethoxy)silane, N-(2-aminoethyl)-3-aminopropyl methyl dimethoxy silane, N-(2-aminoethyl)-3-aminopropyl trimethoxy silane, 3-aminopropyl triethoxy silane, 3-glycidoxy propyl trimethoxy silane, 3-glycidoxy propyl methyl dimethoxy silane, 2-(3,4-epoxy cyclohexyl)ethyl trimethoxy silane, 3-chloro propyl methyl dimethoxy silane, 3-chloro propyl trimethoxy silane, 3-methacryloxy propyl trimethoxy silane, and 3-mercapto propyl trimethoxy silane; an antioxidant such as 2,2-thiobis(4-methyl-6-t-butylphenol) and 2,6-di-t-butylphenol; an ultraviolet absorber such as 2-(3-t-butyl-5-methyl-2-hydroxyphenyl)-5-chlorobenzo triazole and alkoxy benzophenone; an aggregation inhibitor such as sodium polyacrylate; a stabilizer of discharge performance of an ink-jet method such as methanol, ethanol, i-propanol, n-butanol, and glycerin; a surfactant such as FTOP-EF301, FTOP-EF303 and FTOP-EF352 (produced by JEMCO Inc.), MEGAFACK F171, MEGAFACK F172, MEGAFACK F173, MEGAFACK F178K (produced by DIC Corporation), Flolard FC430, Flolard FC431 (produced by Sumitomo 3M Limited), AsahiGuard AG710, Surflon S-382, Surflon SC-101, Surflon SC-102, Surflon SC-103, Surflon SC-104, Surflon SC-105, Surflon SC-106 (produced by ASAHI GLASS CO., LTD.), KP341 (produced by Shin-Etsu Chemical Co., Ltd.), Poly-Flow No. 75 and Poly-Flow No. 95 (produced by KYOEISHA CHEMICAL CO., LTD.); and the like.

A thermal acid generating agent and an acid crosslinking agent may also be contained in the ink 2. The thermal acid generating agent is a component which generates an acid by heat. Examples of the thermal acid generating agent include an onium salt such as a sulfonium salt, a benzothiazolium salt, an ammonium salt and a phosphonium salt, and the like. Among these salts, the sulfonium salt and the benzothiazolium salt are especially preferable.

Ink Set

As described above, the ink 2 is used for manufacturing a color filter 1 by an ink jet method. Generally, such a color filter 1 has coloring parts having predetermined different colors (that is, three colors of RGB corresponding to three primary colors of light). The coloring parts 12 having predetermined different colors are formed by using the inks 2 having colors which correspond to the predetermined different colors of the coloring parts 12, respectively. That is to say, an ink set that contains the inks 2 having the different colors (RGB) is used in manufacturing the color filter 1. In other words, each ink contained in the ink set is constituted from the ink 2 as described above.

In this regard, it is to be noted that in manufacturing a color filter 1, it is preferable that the ink 2 as described above is used for forming coloring parts 12 for at least one specified color, and it is more preferable that the ink (inks) 2 as described above are used for forming coloring parts 12 for all the colors. However, it goes without saying that other inks for a color filter may be used instead of the inks 2 described above.

Color Filter

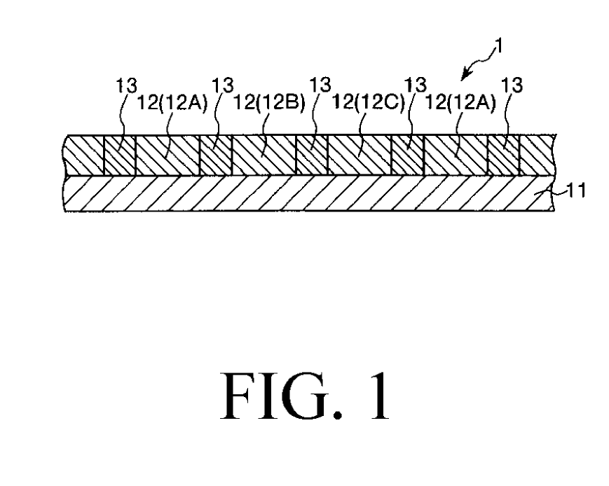

Next, a description will be made with regard to one example of a color filter which is manufactured using inks 2 for use in a color filter (ink set) as described above. FIG. 1 is a cross section view which shows a preferred embodiment of the color filter 1 according to the present invention.

As shown in FIG. 1, the color filter 1 includes a substrate 11 and coloring parts 12 formed on the substrate 11 by using the inks 2 for use in a color filter 1 described above (here in after, simply referred to as “ink 2” or “inks 2” on occasion). The coloring parts 12 include first coloring parts 12A, second coloring parts 12B and third coloring parts 12C which have different colors, respectively. Further, partitioning walls 13 are also formed on the substrate 11 between the adjacent coloring parts 12.

Substrate

The substrate 11 is a plate-shaped member having a light transmissive property, and has a function of supporting the coloring parts 12 and the partitioning walls 13. In this regard, it is preferred that the substrate 11 is formed of a substantially transparent material. This makes it possible to form a clearer image by light transmitting through the color filter 1.

Further, it is also preferred that the substrate 11 is formed of a constituent material having good heat resistance and mechanical strength. By using such a constituent material, it is possible to prevent deformation from occurring by heat applied in manufacturing the color filter 1. Examples of such a constituent material include glass, silicon, polycarbonate, polyester, aromatic polyamide, polyamideimide, polyimide, norbornene based ring-opening copolymer and its hydrogen additive and the like.

Coloring Parts

The coloring parts 12 are formed using the inks 2 as described above. Since the coloring parts 12 are formed using the inks 2 as described above, there is small variation in properties among the respective pixels. Therefore, the manufactured color filter 1 can have high reliability because generation of uneven color and uneven density are reliably prevented.

Each of the coloring parts 12 is provided in a cell 14 which is a region surrounded by the partitioning walls 13 (a region to which the ink 2 is to be ejected) which will be described later in detail.

The first coloring parts 12A, second coloring parts 12B, and third coloring parts 12C have different colors from each other. For example, the first coloring parts 12A may be formed into red filter regions (R), the second coloring parts 12B may be formed into green filter regions (G), and the third coloring parts 12C may be formed into blue filter regions (B).

In this example, a set of the first coloring part 12A, second coloring part 12B, and third coloring part 12C having different colors constitutes one pixel. In the color filter 1, a predetermined large number of pixels are arranged in lateral and longitudinal directions thereof.

For example, in the case where the color filter 1 is a color filter for a high vision TV display, 1366×768 pixels are arranged in lateral and longitudinal directions thereof. Further, in the case where the color filter 1 is a color filter for a full high vision TV display, 1920×1080 pixels are arranged in lateral and longitudinal directions thereof.

Furthermore, in the case where the color filter 1 is a color filter for a super high vision TV display, 7680×4320 pixels are arranged in lateral and longitudinal directions thereof. In this regard, it is to be noted that the color filter 1 may be of the type that additional pixels are arranged outside of an effective area thereof.

Partitioning Walls

As described above, the partitioning walls (banks) 13 are provided between the adjacent coloring parts 12. By the provision of the partitioning walls 13, it is possible to prevent the inks 2 of the adjacent coloring parts 12 from being mixed to each other, and thus it is possible to display a clear color image reliably.

The partitioning walls 13 may be formed of a transparent material, but it is preferable that the partitioning walls 13 are formed of a material having a light shading property. This makes it possible to display a color image having excellent contrast. A color of the partitioning walls 13 (light shading part) is not particularly limited to a specific color, but it is preferable that the partitioning walls 13 are colored with black. This also makes it possible to display a color image having excellent contrast.

The height of the partitioning walls 13 is also not limited to a specific height, but it is preferable that the height of the partitioning walls 13 is higher than the film thickness of each of the coloring parts 12. This makes it possible to prevent the inks 2 of the adjacent coloring parts 12 from being mixed to each other.

The actual thickness of the partitioning walls 13 is preferably in the range of 0.1 to 10 μm, and more preferably in the range of 0.5 to 3.5 μm. This also makes it possible to prevent the inks 2 of the adjacent coloring parts 12 from being mixed to each other. Further, it is also possible to obtain an image display device 1000 provided with the color filter 1 and an electronic apparatus provided with such an image display device 100 which have excellent view angle characteristics.

The partitioning walls 13 may be formed of any constituent material, but it is preferable that the partitioning walls 13 are mainly formed of a resin material. This makes it possible to easily form partitioning walls 13 having a desired shape. Further, in the case where the partitioning walls 13 have a function of the light shading part, the constituent material thereof may contain a material having a light absorbing property such as carbon black.

Droplet Ejection Apparatus

Hereinbelow, one example of droplet ejection apparatus 100 which is used for manufacturing a color filter 1 (ink supply process) will be explained.

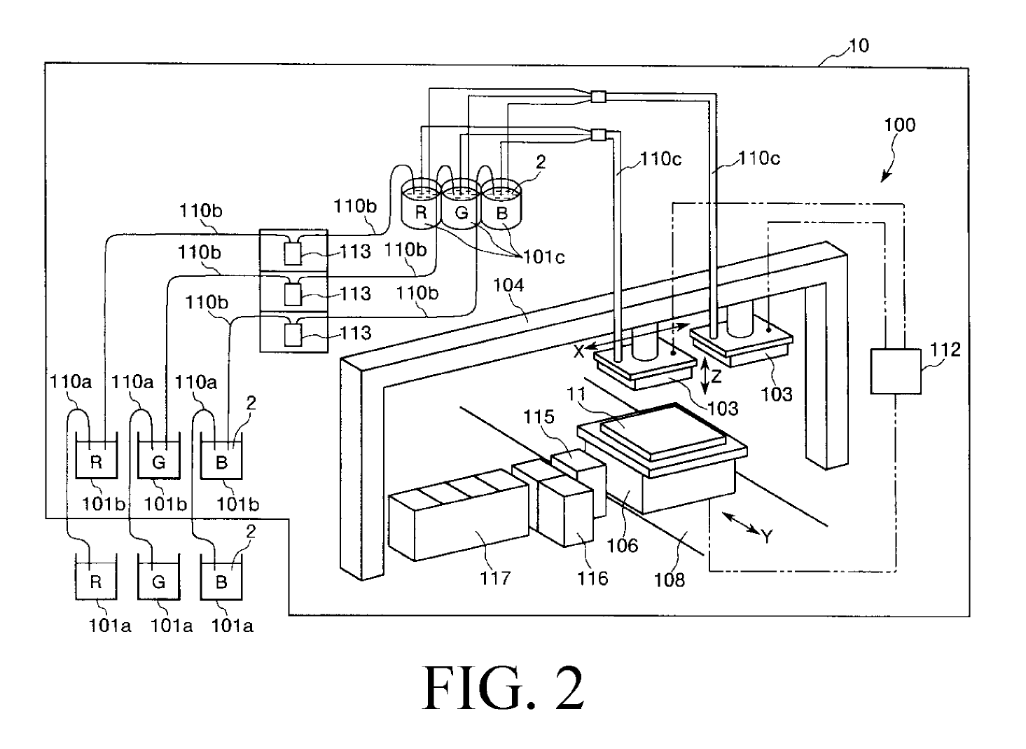

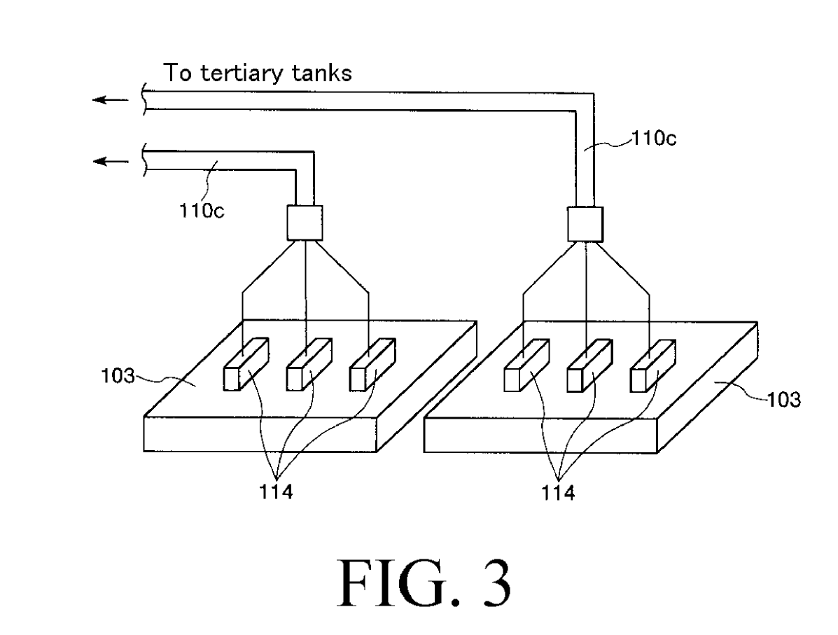

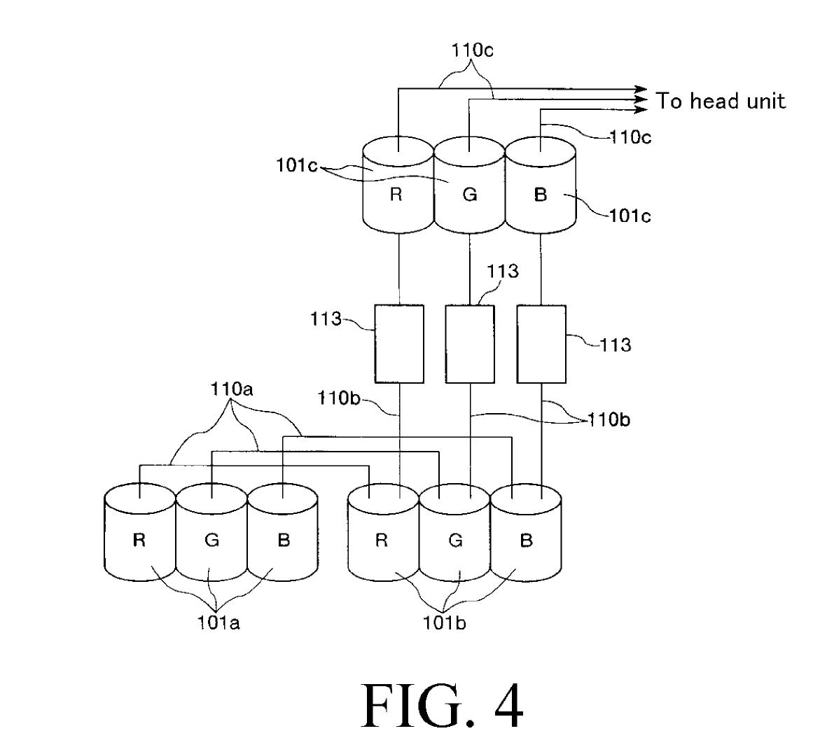

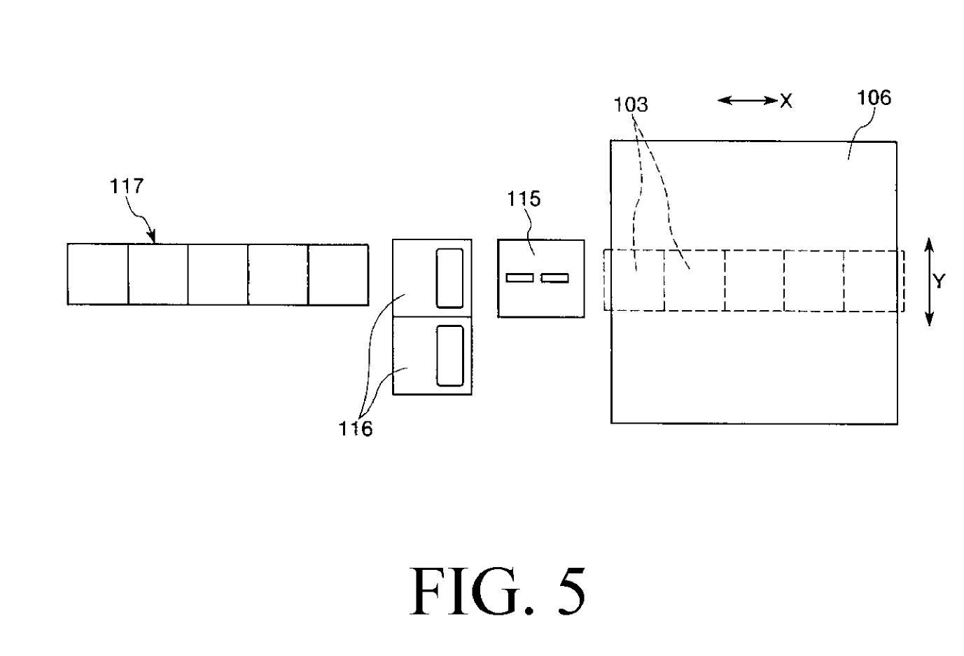

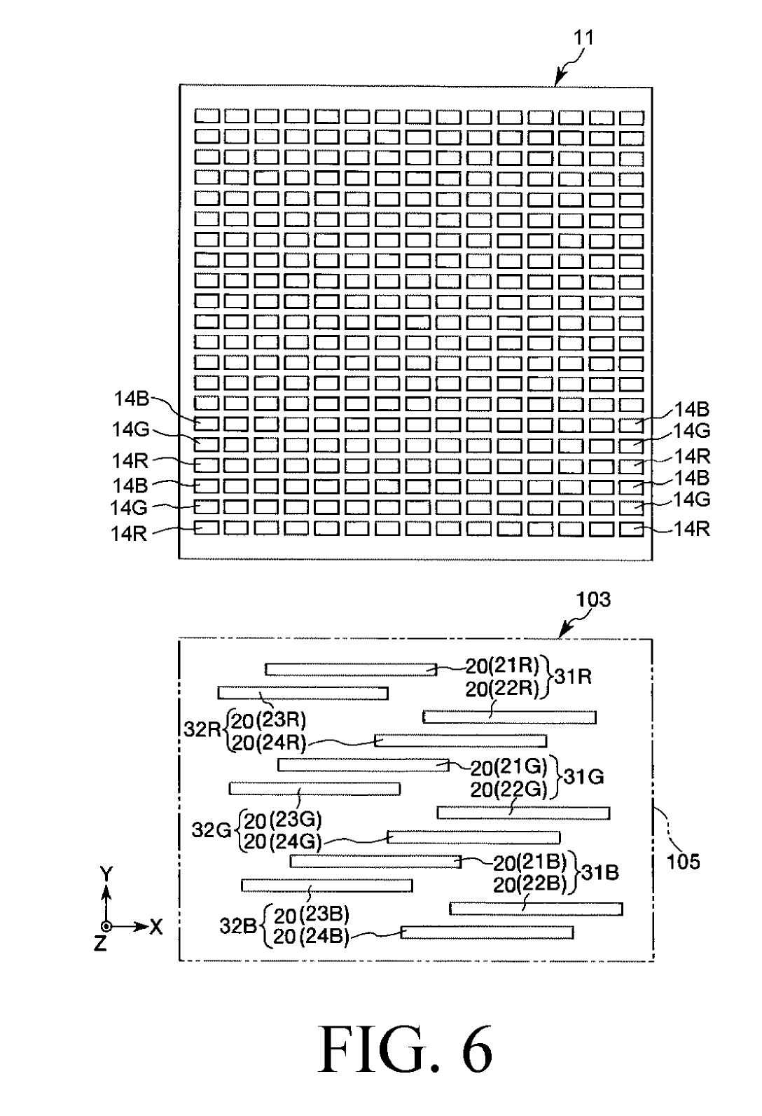

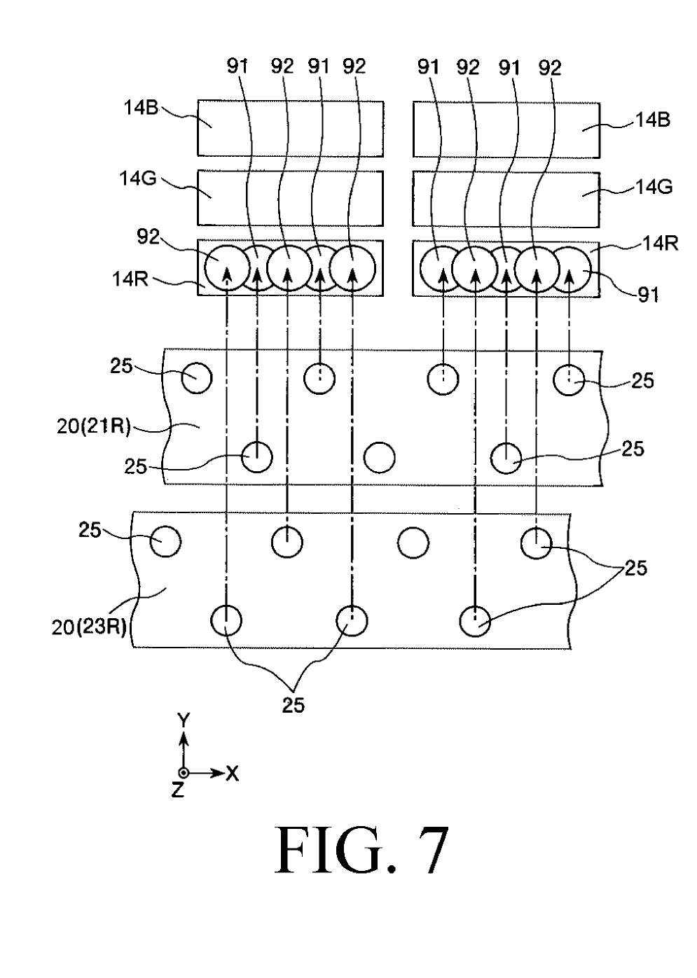

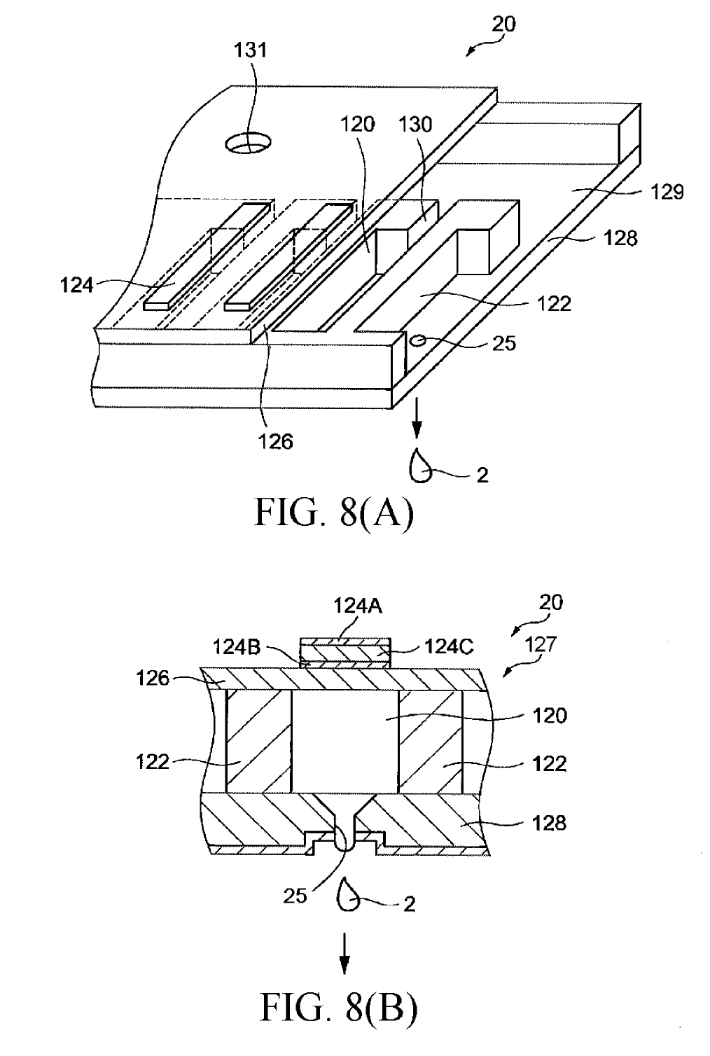

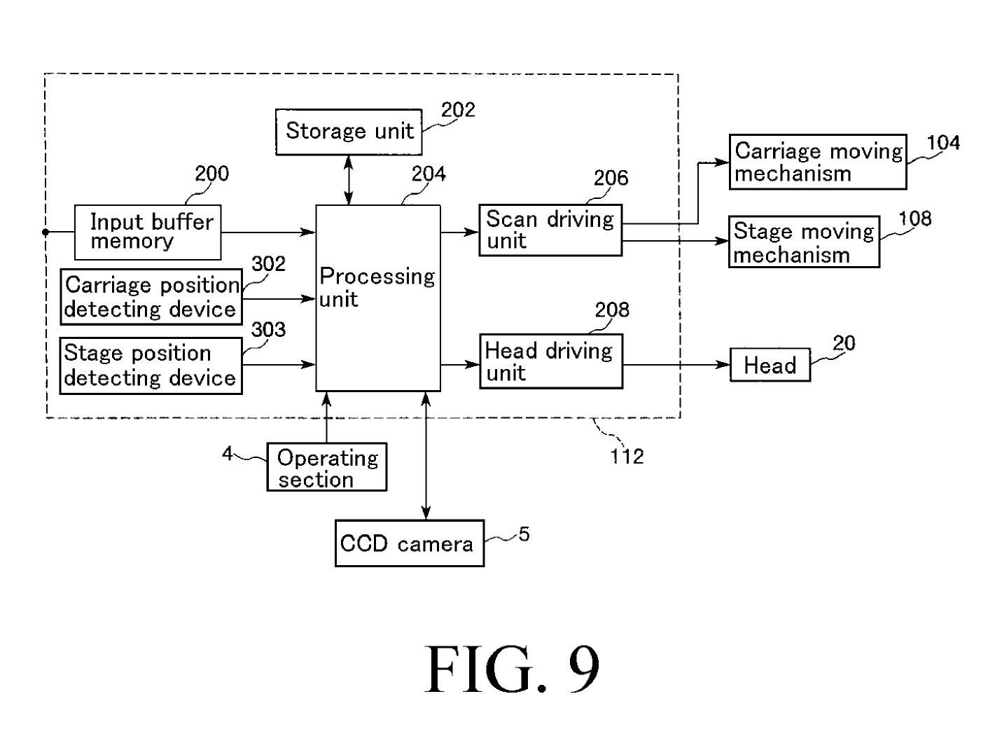

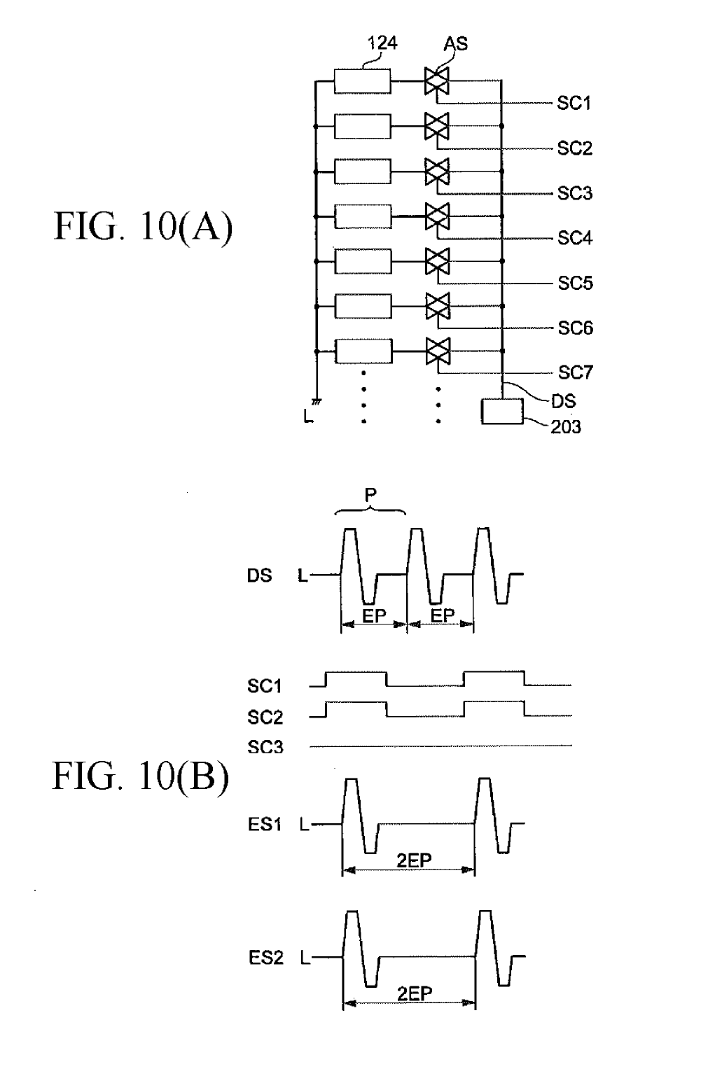

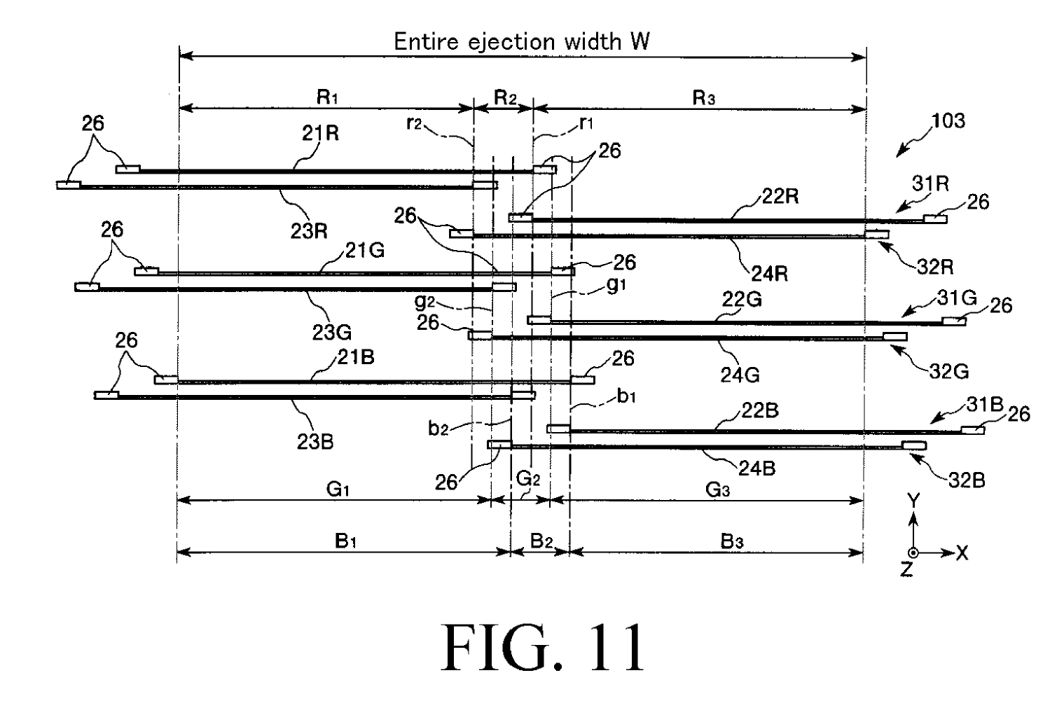

FIG. 2 is a perspective view of a droplet ejection apparatus which can be used in manufacturing the color filter; FIG. 3 is a perspective view which shows a head unit of the droplet ejection apparatus shown in FIG. 2; FIG. 4 is an illustration which shows an ink supply system used in the droplet ejection apparatus shown in FIG. 2; FIG. 5 is a schematic plan view of the droplet ejection apparatus shown in FIG. 2 (a part thereof is omitted); FIG. 6 is a plan view which shows a head unit of the droplet ejection apparatus shown in FIG. 2 and a substrate provided with a number of cells; FIG. 7 is an enlarged plan view which shows a part of a nozzle surface (nozzle plate) of the droplet ejection heads and cells of the substrate; FIG. 8(a) and FIG. 8(b) are respectively a perspective cross-sectional view and a cross sectional view of the droplet ejection head of the droplet ejection apparatus shown in FIG. 2; FIG. 9 is a block diagram of the droplet ejection apparatus shown in FIG. 2; FIG. 10(a) is a schematic view of a head driving unit, and FIG. 10(b) is a timing chart which shows a driving signal, a selecting signal and an ejection signal for the head driving unit; and FIG. 11 is a schematic plan view which explains the positional relationship of each of the droplet ejection heads in the head unit of the droplet ejection apparatus shown in FIG. 2.

Overall Configuration of Droplet Ejection Apparatus

The droplet ejection apparatus 100 shown in FIG. 2 is an apparatus which ejects droplets of inks 2 for a color filter 1 (liquid materials) from nozzles 25 by means of an ink jet method, and it is provided inside a chamber (thermal chamber) wherein temperature and moisture of the inside thereof are adapted to be controlled. The droplet ejection apparatus 100 is provided with a plurality of head units 103.

Each of the head units 103 includes a plurality of droplet ejection heads (ink jet heads) 20 which are mounted on a carriage 105; a carriage moving mechanism (moving mechanism) 104 for moving the head unit 103 in one horizontal direction (hereinafter, referred to as an “X axis direction”); a stage 106 for supporting a substrate 11 on which a number of cells 14 are provided (hereinafter, simply referred to as “substrate”); a stage moving mechanism (moving mechanism) 108 for moving the stage 106 in a horizontal direction perpendicular to the X axis direction (hereinafter, referred to as a “Y axis direction”); and a control unit 112 for controlling the head unit 103, the carriage moving mechanism 104 and the stage moving mechanism 108.

In this regard, it is to be noted that in the droplet ejection apparatus 100 shown in the drawing, two head units 103 are provided, but the number of the head unit 103 is not limited thereto, and the number of the head unit 103 may be one or three or more.

Further, the droplet ejection apparatus 100 includes three primary tanks 101a (ink containers) for respectively storing three kinds of inks 2 including red (R), green (G) and blue (B), three secondary tanks 101b (ink containers) for respectively storing the three kinds of inks 2 including red (R), green (G) and blue (B), and three tertiary tanks 101c (ink containers) for respectively storing the three kinds of inks 2 including red (R), green (G) and blue (B).

In the following description, in the case where the inks 2 of red (R), green (G) and blue (B) are distinctly referred, these inks 2 are respectively referred to as red ink 2R, green ink 2G and blue ink 2B, and in the case where these inks 2 are collectively referred, they are simply referred to as “ink 2 for a color filter” or “ink 2”.

As shown in FIG. 2 and FIG. 4, each primary tank 101a is connected to the corresponding secondary tank 101b through a tube 110a functioning as a flow path for sending the ink 2. Further, each secondary tank 101b is connected to the corresponding tertiary tank 101c through a tube 110b functioning as a flow path for sending the ink 2. On the midway of the tube 110b, there is provided an ink filter 113 (deairing module) for removing air bubbles.

Furthermore, each of the tertiary tanks 101c is connected to each of the head units 103 via a tube 110c functioning as a flow path for sending the ink 2. The ink 2 stored in each of the tanks 101a, b, c is sent (supplied) to each of the droplet ejection heads 20 in the head unit 103.

As shown in FIG. 3, on each of the head units 103, there are provided self-sealing valves 114 which serve as pressure control means. The tubes 110c are connected to the head units 103 through these valves 114. With this structure, a predetermined pressure (negative pressure) is applied to each of the droplet ejection heads 20, thereby enabling nozzles 25 of each droplet ejection head 20 to maintain a satisfactory droplet ejection state.

In this droplet ejection apparatus 100, each of the tertiary tanks 101c is provided at a position higher than the position of the head units 103. This makes it possible to supply the ink 2 from each tertiary tank 101c to the corresponding droplet ejection heads 20 with the aid of gravity.

The operation of the carriage moving mechanism 104 is controlled by the control unit 112. The carriage moving mechanism 104 in the present embodiment has a function of adjusting the height of each head unit 103 by moving the head unit 103 along a vertical direction (hereinafter, referred to as a “Z axis direction”). Further, the carriage moving mechanism 104 also has a function of rotating each head unit 103 around an axis parallel to the Z axis direction, and this makes it possible to finely adjust the angle of the head unit 103 around the Z axis.

The stage 106 has a plane parallel to both the X axis direction and the Y axis direction. Further, the stage 106 is constructed so that the substrate 11 used for manufacturing a color filter 1 can be fixed or held (or supported) on the plane thereof.

The stage moving mechanism 108 moves the stage 106 along the Y axis direction perpendicular to both the X axis direction and the Z axis direction. The operation of the stage moving mechanism 108 is controlled by the control unit 112. Further, the stage moving mechanism 108 in the present embodiment also has a function of rotating the stage 106 around an axis parallel to the Z axis direction, and this makes it possible to correct the position of the substrate 11 by finely adjusting the slant of the substrate 11 mounted on the stage 106 around the Z axis direction so that the substrate 11 is correctly aligned with respect to the head unit 103.

As described above, the head unit 103 is moved along the X axis direction by means of the carriage moving mechanism 104. On the other hand, the stage 106 is moved along the Y axis direction by means of the stage moving mechanism 108. Therefore, a relative position of the head unit 103 with respect to the stage 106 can be changed by the carriage moving mechanism 104 and the stage moving mechanism 108.

Further, as shown in FIG. 5, the droplet ejection apparatus 100 includes a weight measuring unit 115 and two wipe units 116, and cap units 117. In this regard, it is to be noted that FIG. 5 shows one example where five head units 103 and corresponding cap units 117 are provided.

The weight measuring unit 115 is a device which measures weight of an ink 2 ejected from each of the droplet ejection heads 20 for each of the droplet ejection heads 20.

Further, the wipe unit 116 is a device which wipes a nozzle surface of each of the droplet ejection heads 20. Furthermore, the cap unit 117 is a device which caps the droplet ejection head 20 of the head unit 103 when the head unit 103 is in a stand-by state. In this regard, the detailed construction and function of the control unit 112 will be described later.

Head Unit

The head unit 103 shown in FIG. 6 has a structure in which the plurality of droplet ejection heads 20 are mounted on the carriage 105. The carriage 105 is shown in FIG. 6 with a chain double-dashed line. Further, solid lines which respectively show the plurality of droplet ejection heads 20 indicate the positions of nozzle surfaces (that is, nozzle plates 128 described later) of the plurality of droplet ejection heads 20.

Four droplet ejection heads 20 for ejecting the red ink 2R, four droplet ejection heads 20 for ejecting the green ink 2G and four droplet ejection heads 20 for ejecting the blue ink 2B are provided on the head unit 103. The four droplet ejection heads 20 for ejecting the red ink 2R include a first droplet ejection head 21R, a second droplet ejection head 22R, a third droplet ejection head 23R and a fourth droplet ejection head 24R.

The four droplet ejection heads 20 for ejecting the green ink 2G include a first droplet ejection head 21G, a second droplet ejection head 22G, a third droplet ejection head 23G and a fourth droplet ejection head 24G. The four droplet ejection heads 2 for ejecting the blue ink 2B include a first droplet ejection head 21B, a second droplet ejection head 22B, a third droplet ejection head 23B and a fourth droplet ejection head 24B. These twelve droplet ejection heads 20 are provided on the head unit 103.

In the following description, in the case where these droplet ejection heads 20 are correctively referred without distinguishing them by the colors of the inks 2 to be ejected, each of them is referred to simply as the “droplet ejection head 20”. On the other hand, in the case where these droplet ejection heads 20 are distinctly referred respectively for ejecting the inks 2 of red 2R, green 2G and blue 2B, they are referred to as, for example, “the first droplet ejection head 21R, the second droplet ejection head 22R, . . . ”.

The substrate 11 shown in FIG. 6 is a base material for manufacturing a color filter 1 for a liquid-crystal display, on which a number of cells 14 are arranged in a matrix manner. These cells 14 include a plurality of red cells (ejection regions) 14R, a plurality of green cells (ejection regions) 14G and a plurality of blue cells (ejection regions) 14B. The droplet ejection apparatus 1 operates so that the red ink 2R is supplied into each of the red cells 14R, the green ink 2G is supplied into each of the green cells 14G, and the blue ink 2B is supplied into each of the blue cells 14B.

In the following description, in the case where these cells 14 are correctively referred, they are simply referred to as “cells 14”. On the other hand, in the case where these cells 14 are distinctly referred respectively, they are referred to as, for example, “cells 14R or cell 14R”, “cells 14G or cell 14G”, and “cells 14B or cell 14B”.

Each of the cells 14R, 14G and 14B has a substantially rectangular shape. The substrate 11 is supported on the stage 106 with the posture in which the long axis direction of each of the cells 14R, 14G and 14B is parallel to the X axis direction and the short axis direction of each of the cells 14R, 14G and 14B is parallel to the Y axis direction.

The plurality of cells 14R, 14G and 14B are arranged on the substrate 11 so as to be repeatedly arranged in this order along the Y axis direction, and so that the cells of the same color are arranged along the X axis direction. A set of cells 14R, 14G and 14B arranged on the substrate 11 in the Y axis direction corresponds to one pixel of the color filter 1 to be manufactured.

Droplet Ejection Head

As shown in FIG. 7, a plurality of nozzles (nozzle holes) 25 are formed on the nozzle surface of each of the droplet ejection heads 20 so as to be linearly aligned along the X axis direction at even intervals. The plurality of nozzles 25 in each of the droplet ejection heads 20 constitute at least one nozzle array.

In this regard, it is to be noted that in the actual apparatus, the nozzle surface of the droplet ejection head 20 is provided so as to face the substrate 11, that is, so as to be directed vertically and downwardly. However, for easy understanding, in FIG. 7, the nozzle surface of the droplet ejection head 20 is shown by a solid line.

In the present embodiment, two nozzle arrays are formed on each of the droplet ejection heads 20 in a parallel manner so as to be shifted with a half pitch with respect to each other. However, the invention is not limited thereto. The number of nozzle arrays that one droplet ejection head 20 has may be one, or three or more. Further, the number of nozzles 25 that are formed on one droplet ejection head 20 is not particularly limited, and it may normally be in the range of about several dozens to several hundreds.

As shown in FIGS. 8(a) and 8(b), each of the droplet ejection heads 20 constitutes an ink jet head. More specifically, the droplet ejection head 20 is provided with a diaphragm plate 126 and a nozzle plate 128. A reservoir 129 is positioned between the diaphragm (vibration) plate 126 and the nozzle plate 128 so that the reservoir 129 is always filled with the ink 2 supplied from the tertiary tank 101C via an ink intake port 131.

A plurality of partitioning walls 122 are positioned between the diaphragm plate 126 and the nozzle plate 128. Each of cavities 120 is defined by the diaphragm plate 126, the nozzle plate 128 and a pair of partitioning walls 122. Since each cavity 120 is provided so as to be associated with one nozzle 25, the number of cavities 120 is the same as the number of nozzles 25. The ink 2 is supplied to the cavity 120 via an ink supply port 130 provided between the pair of partitioning walls 122.

A vibrator 124 as a driving element is positioned on the diaphragm plate 126 so as to correspond to each of the cavities 120. The vibrator 124 changes liquid pressure of the ink 2 filled within the cavity 120, and includes a piezoelectric element 124C, and a pair of electrodes 124A and 124B between which the piezoelectric element 124C is sandwiched. By applying a driving voltage signal between the pair of electrodes 124A and 124B, the ink 2 is ejected through the corresponding nozzle 25 in the form of droplets.

In this case, by adjusting the driving voltage (e.g., by increasing the driving voltage), it is possible to adjust an ejection amount (volume and/or weight) of the ink 2 ejected from the nozzle 25 per one ejecting operation. The shape of each of the nozzles 25 is adjusted so that the ink 2 is ejected in the Z axis direction through each nozzle 25.

The control unit 112 shown in FIG. 2 may be constructed to apply a driving voltage signal to each of the plurality of vibrators 124 independently from each other or may be constructed to apply a common driving voltage signal to a plurality of vibrators 124. In other words, a volume of the ink 2 to be ejected through each of the nozzles 25 may be controlled in accordance with the driving voltage signal (that is, driving voltage) from the control unit 112 per each nozzle 25, or may be controlled in every sets of the plurality of nozzles 25.

Further, the control unit 112 may determine nozzles 25 which carry out ejecting operation during the ink supplying step and nozzles (disable nozzles) 25 which do not carry out ejecting operation during the ink supplying step.

In this regard, it is to be noted that in this specification a portion of the nozzle head 20 which includes one nozzle 25, a cavity 120 corresponding to the nozzle 25 and a vibrator 124 corresponding to the cavity 12 is referred to as “ejection portion 127” on occasions. According to this case, one droplet ejection head 20 includes ejection portions 127 of which number is the same as the number of the nozzles 25.

Further, in the present invention, the droplet ejection head 20 may use an electrostatic actuator instead of the piezoelectric actuator as a driving element. Furthermore, the droplet ejection head 20 may use an electro-thermal converting element instead of the piezoelectric actuator as a driving element so that the ink 2 is ejected in the form of droplets using thermal expansion of the ink 2 by means of the electro-thermal converting element.

Positional Relationship of Four Droplet Ejection Heads in the Head Unit

As described above, four droplet ejection heads 20 for ejecting the red ink 2R, four droplet ejection heads 20 for ejecting the green ink 2G and four droplet ejection heads 20 for ejecting the blue ink 2B are provided on the head unit 103. The four droplet ejection heads 20 for ejecting the red ink 2R include a first droplet ejection head 21R, a second droplet ejection head 22R, a third droplet ejection head 23R and a fourth droplet ejection head 24R.

The four droplet ejection heads 20 for ejecting the green ink 2G include a first droplet ejection head 21G, a second droplet ejection head 22G, a third droplet ejection head 23G and a fourth droplet ejection head 24G. The four droplet ejection heads 20 for ejecting the blue ink 2B include a first droplet ejection head 21B, a second droplet ejection head 22B, a third droplet ejection head 23B and a fourth droplet ejection head 24B. These twelve droplet ejection heads 20 are provided on the head unit 103. In this regard, it is to be noted that elongated line shapes shown in FIG. 11 show positions of the nozzle arrays of these droplet ejection heads 20.

Further, in the structure shown in FIG. 11, in each of the droplet ejection heads 20, a predetermined number of nozzles at both ends of each nozzle array (e.g., about ten nozzles) are configured so that they are not used for ejecting the ink 2 (hereinafter, these nozzle will be referred to as “disable nozzles”).

In FIG. 11, in each of the elongated line shapes which represent the nozzle arrays, rectangular shapes at the both ends of each nozzle array indicate nonuse portions 26 where such disable nozzles 25 are provided, respectively.

First, a description will be made with regard to the positional relationship among the four droplet ejection heads 20 for ejecting the red ink 2R. The four droplet ejection heads 20 for ejecting the red ink 2R include a first droplet ejection head 21R, a second droplet ejection head 22R, a third droplet ejection head 23R and a fourth droplet ejection head 24R.

The first droplet ejection head 21R and the second droplet ejection head 22R are arranged in a consecutive manner in a first direction (that is, X axis direction) parallel to each of the nozzle arrays, and the two nozzle arrays of the first and second droplet ejection heads 21R and 22R are arranged so that the nozzles 25 thereof are consecutive via a seam r₁ between the two adjacent nozzle arrays of the first and second droplet ejection heads 21R and 22R when viewed from a second direction (that is, Y axis direction) perpendicular to each of the nozzle arrays.

In this case, the two nozzle arrays of the first and second droplet ejection heads 21R and 22R function as a long nozzle array. In other words, a nozzle pitch at the seam r₁ when viewed from the Y axis direction is set to become a regular length similar to a nozzle pitch in the nozzle array. The long nozzle array constituted from the first and second droplet ejection heads 21R and 22R arranged with such a positional relationship is referred to as a head array 31R.

In this regard, in consideration of the nonuse portions 26 of respective one ends of the first and second droplet ejection heads 21R and 22R, the first and second droplet ejection heads 21R and 22R are arranged so that the right end portion in FIG. 11 of the nozzle array in the first droplet ejection head 21R (disable nozzles) and the left end portion in FIG. 11 of the nozzle array in the second droplet ejection head 22R (disable nozzles) overlap each other in the vicinity of the seam r₁ of the nozzle arrays when viewed from the Y axis direction.

In a similar manner, the third droplet ejection head 23R and the fourth droplet ejection head 24R are arranged in a consecutive manner in the first direction (that is, X axis direction) parallel to each of the nozzle arrays, and the two nozzle arrays of the third and fourth droplet ejection heads 23R and 24R are arranged so that the nozzles 25 thereof are consecutive via a seam r₂ between the two adjacent nozzle arrays of the third and fourth droplet ejection heads 23R and 24R when viewed from the second direction (that is, Y axis direction) perpendicular to each of the nozzle arrays.

In this case, the two nozzle arrays of the third and fourth droplet ejection heads 23R and 24R function as a long nozzle array. In other words, a nozzle pitch at the seam r₂ when viewed from the Y axis direction is set to become a regular length similar to a nozzle pitch in the nozzle array. The long nozzle array constituted from the third and fourth droplet ejection heads 23R and 24R arranged with such a positional relationship is referred to as a head array 32R.

In this regard, in consideration of the nonuse portions 26 of respective one ends of the third and fourth droplet ejection heads 23R and 24R, the third and fourth droplet ejection heads 23R and 24R are arranged so that the right end portion in FIG. 11 of the nozzle array in the third droplet ejection head 23R (disable nozzles) and the left end portion in FIG. 11 of the nozzle array in the fourth droplet ejection head 24R (disable nozzles) overlap each other in the vicinity of the seam r₂ of the nozzle arrays when viewed from the Y axis direction.

The long nozzle array formed from the head array 31R described above and the long nozzle array formed from the head array 32R described above are arranged by overlapping them so that the seams r₁ and r₂ are shifted with respect to each other in the X axis direction when viewed from the Y axis direction.

The droplet ejection apparatus 100 can eject the red ink 2R in the form of droplets onto one cell 14R through the nozzles 25 of a plurality of different droplet ejection heads 20 (in the present embodiment, two droplet ejection heads 20) using such an overlap.

For example, in the case of the cell 14R to which the red ink 2 is ejected in the form of droplets using an area indicated as R₁ in FIG. 11 where the first and third droplet ejection heads 21R and 23R are overlapped when viewed from the Y axis direction, as shown in FIG. 7, the droplets 91 ejected through the nozzles 25 of the first droplet ejection head 21R and the droplets 92 ejected through the nozzles 25 of the third droplet ejection head 23R are supplied thereto.

In this regard, in FIG. 7, although the position of the nozzles 25 in the head array 31R (herein, the first droplet ejection head 21R) and the position of the nozzles 25 in the head array 32R (herein, the third droplet ejection head 23R) are shifted with respect to each other in the X axis direction when viewed from the Y axis direction, the head arrays 31R and 32R may be arranged so that the positions of the nozzles 25 in each of the head arrays 31R and 32R correspond with each other.

Although it is not shown in the drawings (in particular, in FIG. 7), in the case of the cell 14R to which the red ink 2R is ejected in the form of droplets using an area indicated as R₂ in FIG. 11 where the first and fourth droplet ejection heads 21R and 24R are overlapped when viewed from the Y axis direction, the droplets ejected through the nozzles 25 of the first droplet ejection head 21R and the droplets ejected through the nozzles 25 of the fourth droplet ejection head 24R are supplied thereto.

Further, in the case of the cell 14R to which the red ink 2R is ejected in the form of droplets using an area indicated as R₃ in FIG. 11 where the second and fourth droplet ejection heads 22R and 24R are overlapped when viewed from the Y axis direction, the droplets ejected through the nozzles 25 of the second droplet ejection head 22R and the droplets ejected through the nozzles 25 of the fourth droplet ejection head 24R are supplied thereto.

Next, a description will be made with regard to the positional relationship among the four droplet ejection heads 20 for ejecting the green ink 2G. The four droplet ejection heads 20 for ejecting the green ink 2G include a first droplet ejection head 21G, a second droplet ejection head 22G, a third droplet ejection head 23G and a fourth droplet ejection head 24G.

The positional relationship of the four droplet ejection heads 2 including the first to fourth droplet ejection heads 21G to 24G for ejecting the green ink 2G is similar to the positional relationship of the four droplet ejection heads 2 including the first to fourth droplet ejection heads 21R to 24R for ejecting the red ink 2R. For this reason, hereinafter, the description of such positional relationship will be simplified.

The first droplet ejection head 21G and the second droplet ejection head 22G are arranged in a consecutive manner in the X axis direction parallel to each of the nozzle arrays, and the two nozzle arrays of the first and second droplet ejection heads 21G and 22G are arranged so that the nozzles 25 thereof are consecutive via a seam g₁ between the two adjacent nozzle arrays of the first and second droplet ejection heads 21G and 22G when viewed from the Y axis direction perpendicular to each of the nozzle arrays (that is, the X axis direction).

In this case, the two nozzle arrays of the first and second droplet ejection heads 21G and 22G function as a long nozzle array. The long nozzle array constituted from the first and second droplet ejection heads 21G and 22G arranged with such a positional relationship is referred to as a head array 31G.

In a similar manner, the third droplet ejection head 23G and the fourth droplet ejection head 24G are arranged in a consecutive manner in the X axis direction parallel to each of the nozzle arrays, and the two nozzle arrays of the third and fourth droplet ejection heads 23G and 24G are arranged so that the nozzles 25 thereof are consecutive via a seam g₂ between the two adjacent nozzle arrays of the third and fourth droplet ejection heads 23G and 24G when viewed from the Y axis direction perpendicular to each of the nozzle arrays (that is, the X axis direction).

In this case, the two nozzle arrays of the third and fourth droplet ejection heads 23G and 24G function as a long nozzle array. The long nozzle array constituted from the third and fourth droplet ejection heads 23G and 24G arranged with such a positional relationship is referred to as a head array 32G.

The long nozzle array formed from the head array 31G described above and the long nozzle array formed from the head array 32G described above are arranged by overlapping them so that the seams g₁ and g₂ are shifted with respect to each other in the X axis direction when viewed from the Y axis direction. The droplet ejection apparatus 1 can eject the green ink 2G in the form of droplets to one cell 14G through the nozzles 25 of a plurality of different droplet ejection heads 20 (in the present embodiment, two droplet ejection heads 20) using such an overlap.

In other words, in the case of the cell 14G to which the ink 2G is ejected in the form of droplets using an area indicated as G₁ in FIG. 11 where the first and third droplet ejection heads 21G and 23G are overlapped when viewed from the Y axis direction, the droplets ejected through the nozzles 25 of the first droplet ejection head 21G and the droplets ejected through the nozzles 25 of the third droplet ejection head 23G are supplied thereto.

Further, in the case of the cell 14G to which the green ink 2G is ejected in the form of droplets using an area indicated as G₂ in FIG. 11 where the first and fourth droplet ejection heads 21G and 24G are overlapped when viewed from the Y axis direction, the droplets ejected through the nozzles 25 of the first droplet ejection head 21G and the droplets ejected through the nozzles 25 of the fourth droplet ejection head 24G are supplied thereto.

Moreover, in the case of the cell 14G to which the green ink 2G is ejected in the form of droplets using an area indicated as G₃ in FIG. 11 where the second and fourth droplet ejection heads 22G and 24G are overlapped when viewed from the Y axis direction, the droplets ejected through the nozzles 25 of the second droplet ejection head 22G and the droplets ejected through the nozzles 25 of the fourth droplet ejection head 24G are supplied thereto.

Next, a description will be made with regard to the positional relationship among the four droplet ejection heads 20 for ejecting the blue ink 2B. The four droplet ejection heads 2 for ejecting the blue ink 2B include a first droplet ejection head 21B, a second droplet ejection head 22B, a third droplet ejection head 23B and a fourth droplet ejection head 24B.

The positional relationship of the four droplet ejection heads 20 including the first to fourth droplet ejection heads 21B to 24B for ejecting the blue ink 2B is similar to the positional relationship of the four droplet ejection heads 20 including the first to fourth droplet ejection heads 21R to 24R for ejecting the red ink 2R. For this reason, hereinafter, the description of such positional relationship will be simplified.

The first droplet ejection head 21B and the second droplet ejection head 22B are arranged in a consecutive manner in the X axis direction parallel to each of the nozzle arrays, and the two nozzle arrays of the first and second droplet ejection heads 21B and 22B are arranged so that the nozzles 25 thereof are consecutive via a seam b₁ between the two adjacent nozzle arrays of the first and second droplet ejection heads 21B and 22B when viewed from the Y axis direction perpendicular to each of the nozzle arrays (that is, the X axis direction).

In this case, the two nozzle arrays of the first and second droplet ejection heads 21B and 22B function as a long nozzle array. The long nozzle array constituted from the first and second droplet ejection heads 21B and 22B arranged with such a positional relationship is referred to as a head array 31B.

In a similar manner, the third droplet ejection head 23B and the fourth droplet ejection head 24B are arranged in a consecutive manner in the X axis direction parallel to each of the nozzle arrays, and the two nozzle arrays of the third and fourth droplet ejection heads 23B and 24B are arranged so that the nozzles 25 thereof are consecutive via a seam b₂ between the two adjacent nozzle arrays of the third and fourth droplet ejection heads 23B and 24B when viewed from the Y axis direction perpendicular to each of the nozzle arrays (that is, the X axis direction).

In this case, the two nozzle arrays of the third and fourth droplet ejection heads 23B and 24B function as a long nozzle array. The long nozzle array constituted from the third and fourth droplet ejection heads 23B and 24B arranged with such a positional relationship is referred to as a head array 32B.

The long nozzle array formed from the head array 31B described above and the long nozzle array formed from the head array 32B described above are arranged by overlapping them so that the seams b₁ and b₂ are shifted with respect to each other in the X axis direction when viewed from the Y axis direction. The droplet ejection apparatus 1 can eject the blue ink 2B in the form of droplets to one cell 14B through the nozzles 25 of a plurality of different droplet ejection heads 20 (in the present embodiment, two droplet ejection heads 20) using such an overlap.

In other words, in the case of the cell 14B to which the blue ink 2B is ejected in the form of droplets using an area indicated as B₁ in FIG. 11 where the first and third droplet ejection heads 21B and 23B are overlapped when viewed from the Y axis direction, the droplets ejected through the nozzles 25 of the first droplet ejection head 21B and the droplets ejected through the nozzles 25 of the third droplet ejection head 23B are supplied thereto.

Further, in the case of the cell 14B to which the ink 2B is ejected in the form of droplets using an area indicated as B₂ in FIG. 11 where the first and fourth droplet ejection heads 21B and 24B are overlapped when viewed from the Y axis direction, the droplets ejected through the nozzles 25 of the first droplet ejection head 21B and the droplets ejected through the nozzles 25 of the fourth droplet ejection head 24B are supplied thereto.

Moreover, in the case of the cell 14B to which the blue ink 2B is ejected in the form of droplets using an area indicated as B₃ in FIG. 11 where the second and fourth droplet ejection heads 22B and 24B are overlapped when viewed from the Y axis direction, the droplets ejected through the nozzles 25 of the second droplet ejection head 22B and the droplets ejected through the nozzles 25 of the fourth droplet ejection head 24B are supplied thereto.

In such a head unit 103, the long nozzle array formed from the head arrays 31R, 32R for ejecting the red ink 2R, the long nozzle array formed from the head arrays 31G, 32G for ejecting the green ink 2G, and the long nozzle array formed from the head arrays 31B, 32B for ejecting the blue ink 2B are arranged so that they are overlapped when viewed from the Y axis direction. Therefore, it is possible to supply red, green and blue inks 2 to the cells 14R, 14G and 14B at one time over the entire ejection width W by a main scanning operation of the head unit 103 with respect to the substrate 11.

Further, in this droplet ejection apparatus 100, the seams r₁ and r₂ of the nozzle arrays in the head array 31R and 32R for ejecting the green red ink 2G, the seams g₁ and g₂ of the nozzle arrays in the head array 31G and 32G for ejecting the green ink 2G, and the seams b₁ and b₂ of the nozzle arrays in the head array 31B and 32B for ejecting the blue ink 2B are arranged so as to be shifted to each other when viewed from the Y axis direction.

In this regard, it is to be noted that the positional relationship of the droplet ejection heads 20 in the head unit 103 described above is one example, and it goes without saying that other positional relationship may be employed.

Control Unit

Next, the configuration of the control unit 112 will be now described. The control unit 112 may be a computer provided with a CPU (central processing unit), a ROM (read only memory), a RAM and the like. In this case, the operations of the control unit 112 described below are realized using a software program implemented by the computer. Alternatively, the control unit 112 may be realized with a dedicated circuit (that is, using hardware).

As shown in FIG. 9, the control unit 112 is provided with an input buffer memory 200, a storage unit 202, a processing unit 204, a scan driving unit 206, a head driving unit 208, a carriage position detecting device 302, and a stage position detecting device 303. The control unit 112 controls operations of these components of the droplet ejection apparatus 100 according to a predetermined program based on signal from the operating section 4 and a CCD camera (quality information acquiring means) and the like.

The processing unit 204 is electrically connected to each of the input buffer memory 200, the storage unit 202, the scan driving unit 206, and the head driving unit 208 so as to be capable of making communications therebetween. Further, the scan driving unit 206 is electrically connected to both the carriage moving mechanism 104 and the stage moving mechanism 108. Similarly, the head driving unit 208 is electrically connected to each of the plurality of droplet ejection heads 20 in the head unit 103.

The input buffer memory 200 receives data on positions to which droplets of the ink 2 are to be ejected, that is, drawing pattern data from an outer information processing apparatus. The input buffer memory 200 outputs the drawing pattern data to the processing unit 204, and the processing unit 204 then stores the drawing pattern data in the storage unit 202.

The storage unit 202 includes storage medium that stores (records) various information, data, algorisms, tables, programs, and the like. The storage medium may be constructed from a volatile memory such as RAM, a non-volatile memory such as ROM, a rewritable (erasable and rewritable) non-volatile memory such as EPROM, EEPROM, flash memory, various semiconductor memories, IC memories, magnetic recording medium, optic recording medium, magneto-optic recording medium or the like. Various operations to and from the storage unit 202 such as writing (recording), rewriting (overwriting), erasing, reading, and the like are carried out by the processing unit 204.

The carriage position detecting device 302 detects the position of the carriage 105, that is, the position of the head unit 103 in the X axis direction (moving distance of the carriage 105 in the X axis direction), and outputs the detected signal into the processing unit 204.

The stage position detecting device 303 detects the position of the stage 106, that is, the position of the substrate 11 in the Y axis direction (moving distance of the substrate 11 in the Y axis direction), and outputs the detected signal into the processing unit 204.

The carriage position detecting device 302 and the stage position detecting device 303 may be constructed from a linear encoder, a laser length measuring device or the like, for example.

The processing unit 204 controls (in a closed loop) the operations of the carriage moving mechanism 104 and the stage moving mechanism 108 via the scan driving unit 206 on the basis of the detected signals of both the carriage position detecting device 302 and the stage position detecting device 303, thereby controlling the position of the head unit 103 and the position of the substrate 11. Further, the processing unit 204 controls the moving velocity of the stage 106, that is, the substrate 11 by controlling the operation of the stage moving mechanism 108.

Moreover, the processing unit 204 outputs a selection signal SC for specifying ON/OFF of each of the nozzles 25 in each ejection timing to the head driving unit 208 on the basis of the drawing pattern data stored in the storage unit 202. The head driving unit 208 then outputs an ejection signal required to eject the ink 2 to each of the droplet ejection heads 2 on the basis of the selection signal SC. As a result, the ink 2 is ejected in the form of droplets through the corresponding nozzles 25 in each of the droplet ejection heads 20.

Next, the configuration and function of the head driving unit 208 in the control unit 112 will be described. As shown in FIG. 10(a), the head driving unit 208 includes one driving signal generator 203, and a plurality of analog switches AS. As shown in FIG. 10(b), the driving signal generator 203 generates a driving signal DS. Potential of the driving signal DS is temporally changed with respect to a reference potential L.

More specifically, the driving signal DS includes a plurality of ejection waveforms P that repeat with the ejection cycle EP. In this regard, it is to be noted that the ejection waveform P corresponds to a driving voltage waveform to be applied between the pair of electrodes 124A and 124B in the corresponding vibrator 124 in order to eject one droplet through one nozzle 25.

The driving signal DS is supplied to an input terminal of each of the analog switches AS. Each of the analog switches AS is provided in accordance with each of the nozzles 25. Namely, the number of analog switches AS is the same as the number of nozzles 25.

The processing unit 204 outputs the selection signal SC for indicating ON/OFF of each of the nozzles 25 to each of the analog switches AS. In this regard, the selection signal SC can become either a high level state or a low level state independently for each of the analog switches AS. In response to the driving signal DS and the selection signal SC, each of the analog switches AS applies an ejection signal ES to the electrode 124A of the corresponding vibrator 124.

More specifically, in the case where the selection signal SC becomes the high level state, the corresponding analog switch AS is turned ON, and applies the driving signal DS as the ejection signal ES to the corresponding electrode 124A. On the other hand, in the case where the selection signal SC becomes the low level state, the corresponding analog switch AS is turned OFF, and the potential of the ejection signal ES that the corresponding analog switch AS outputs to the corresponding electrode 124A becomes a reference potential L.

When the driving signal DS is applied to the electrode 124A of the vibrator 124, the ink 2 is ejected through the nozzle 25 that corresponds to the vibrator 124. In this regard, the reference potential L is applied to the electrode 124B of each of the vibrators 124.

In an example shown in FIG. 10(b), a high level period and a low level period of each of two selection signals SC are set so that the ejection waveform P appears with a cycle 2EP that is twice the ejection cycle EP in each of two ejection signals ES. Thus, the ink 2 is ejected in the form of droplets through each of the two corresponding nozzles 25 with the cycle 2EP. A common driving signal DS is applied to each of the vibrators 124 that correspond to the two nozzles 25 from a shared driving signal generator 203. For this reason, the ink 2 is ejected through the two nozzles 25 at substantially the same timing.

By using such a droplet ejection apparatus 100, inks 2R, 2G and 2B are supplied into corresponding cells 14R, 14G and 14B, respectively.

In this case, the droplet ejection apparatus 100 operates so that droplets of the inks 2 are ejected through the nozzles 25 of each of the droplet ejection heads 2 in the head unit 103 and supplied (landed) into each of the cells 14R, 14G and 14B on the substrate 11 while moving the substrate 11 supported on the stage 106 in the Y axis direction by the operation of the stage moving mechanism 108, and passing the substrate 11 under the head unit 103. Hereinafter, this operation of the droplet ejection apparatus 100 may be referred to as “main scanning movement between the head unit 103 and the substrate 11”.

In the case where the width of the substrate 11 in the X axis direction is smaller than the length of the entire head unit 103 in the X axis direction (that is, an entire ejection width W described later) to which the inks 2 can be ejected with respect to the substrate 11, it is possible to supply the inks 2 onto the whole of the substrate 11 by carrying out the main scanning movement between the head unit 103 and the substrate 11 once.

On the other hand, in the case where the width of the substrate 11 in the X axis direction is larger than the entire ejection width W of the head unit 103, it is possible to supply the inks 2 onto the whole of the substrate 11 by repeatedly alternating the main scanning movement between the head unit 103 and the substrate 11 and the movement of the head unit 103 in the X axis direction by means of the operation of the carriage moving mechanism 104 (referred to as a “sub-scanning movement”).

Further, the inks 2 can be applied onto one substrate 11 from one head unit 103 or a plurality of head units 103 (two head units in the example shown in FIG. 2). By using the droplet ejection apparatus 100 as described above, it is possible to supply the inks 2 into the cells 14 effectively and selectively.

In this regard, it is to be noted that the droplet ejection apparatus 100 described above is one example, and it goes without saying that other apparatuses having different structures may be employed if they can eject inks for a color filter from nozzles thereof using an ink jet method.

Method of Manufacturing Color Filter

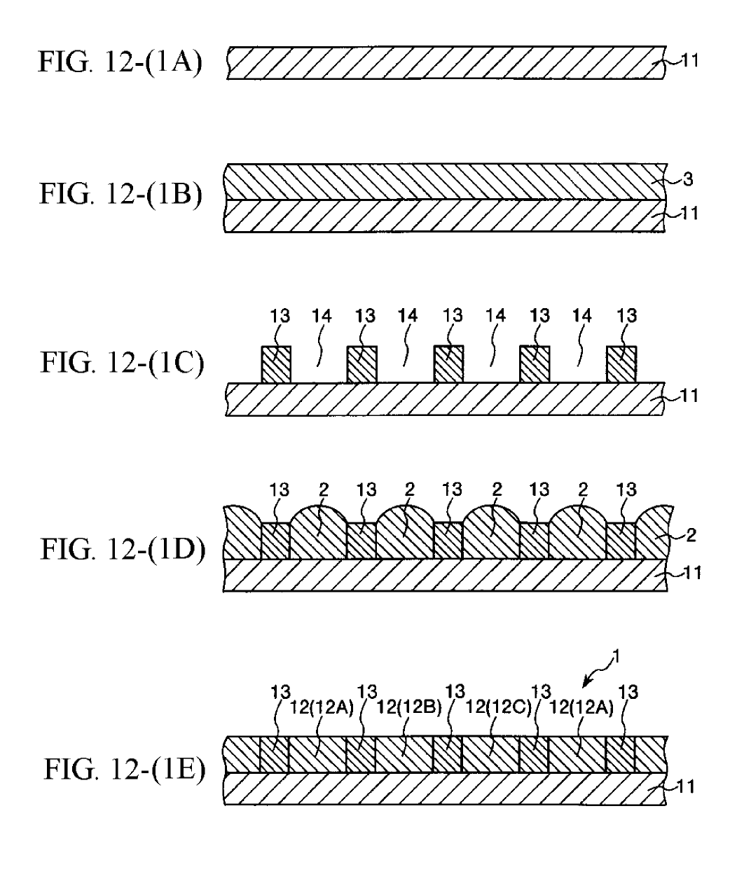

Next, a description will be made with regard to one example of a method of manufacturing a color filter 1. FIG. 12 (1A to 1E) is a cross-sectional view which shows a method of manufacturing a color filter 1 according to the present invention.

As shown in FIG. 12, the manufacturing method of this embodiment includes: (1a) a substrate preparing step for preparing a substrate 11, (1b, 1c) a partitioning wall forming step for forming partitioning walls 13 on the substrate 11, (1d) an ink supplying step for supplying inks 2 into cells 14 that are regions surrounded by the partitioning walls 13, and (1e) a coloring part forming step for removing a liquid medium from the inks 2 to form the coloring parts 12 of a solid state.

Substrate Preparing Step (1a)

First, a substrate 11 is prepared (1a). The substrate 11 prepared in this step has been preferably subjected to a washing treatment. Further, the substrate 11 prepared in this step may be one which has been subjected to a primary treatment such as a chemical treatment using a silane coupling agent or the like, a plasma treatment, ion plating, sputtering, a vapor phase reaction method, a vacuum deposition, or the like.

Partitioning Wall Forming Step (1b, 1c)

Next, a radio-sensitive composition for forming the partitioning walls 13 is applied to one of the entire surfaces of the substrate 11 to thereby form a coating layer 3 (1b). In this regard, it is to be noted that a pre-bake treatment may be carried out after applying the radio-sensitive composition onto the surface of the substrate 11, as necessary. The pre-bake treatment may be carried out under the conditions that, for example, a heating temperature is in the range of 50 to 150° C. and a heating time is in the range of 30 to 600 seconds.

Thereafter, the surface of the substrate 11 is irradiated with radio rays through a photomask to carry out a photo exposure treatment (PEB), and then a development treatment using an alkali development solution to thereby form the partitioning walls 13 on the substrate 11 (1c). The PEB may be carried out under the conditions that, for example, a heating temperature is in the range of 50 to 150° C., a heating time is in the range of 30 to 600 seconds, and a radio ray irradiation intensity is in the range of 1 to 500 mJ/cm².

Further, the development treatment may be carried out by a liquid application method, a dipping method, a vibratory immersion method, or the like. Furthermore, the development treatment time may be in the range of 10 to 300 seconds, for example. Moreover, after the development treatment, a post-bake treatment may be carried out, if necessary.

This post-bake treatment can be carried out under the conditions that, for example, a heating temperature is in the range of 150 to 280° C. and a heating time is in the range of 3 to 120 minutes. In this way, it is possible to obtain a substrate 11 on which a number of regions defined by the partitioning walls 13 are formed, that is, a substrate 11 on which a number of cells 14 are formed.

Ink Supplying Step (1d)

Next, the inks 2 as described above are supplied to cells 14 surrounded by the partitioning walls 13 by an ink jet method (1d).

This step is carried out using a plurality of inks 2 having colors corresponding to the colors of the coloring parts 12 to be formed, that is, this step is carried out using red ink 2R, green ink 2G and blue ink 2B. In this case, since the partitioning walls 13 are provided between the adjacent cells 14, it is possible to reliably prevent two or more inks 2 from being mixed to each other.

Supply of the inks 2 into the cells 14 is carried out using the droplet ejection apparatus 100 described above. Namely, by using the droplet ejection apparatus 100 described above, the inks 2 are supplied into a number of cells 14 formed on the substrate 11 from the nozzles 25 of the droplet ejection heads 20 by an ink jet method based on drawing pattern data, wherein the drawing pattern data provides a pattern for ejecting inks 2 into the respective cells 14 formed on the substrate 11 (e.g., ejecting positions, number of ejecting operations, colors of the inks, and the like).

This step is carried out in a state that the droplet ejection apparatus 100 is placed in a chamber (thermal chamber) of which temperature is set to a predetermined temperature. Normally, the temperature of the chamber in which the droplet ejection apparatus 100 is placed is set at a temperature in the range of 20 to 26° C. By setting the temperature of the chamber within this range, a temperature control of the chamber can be carried out relatively easily.

Further, temperature variations or changes at various portions of the inside of the chamber which are caused by heat generated by the droplet ejection apparatus 100 can be made to be relatively small. Furthermore, an amount of energy required by the temperature control such as an electrical power and the like can be also reduced. Moreover, since a temperature inside a clean room is normally set within the above range, an existing clean room can be preferably used for manufacturing the color filter 1. Normally, the temperature inside the chamber is set within the range of 0.5 to 1.5° C. (±0.25 to ±0.75° C.).

As described above, the temperature inside the chamber in which the droplet ejection apparatus 100 is placed is preferably set in the range of 20 to 26° C., more preferably in the range of 21 to 25° C., and even more preferably in the range of 22 to 24° C. This makes it possible to exhibit the effects described above conspicuously. Further, it is also possible to make ejection stability of the inks 2 especially excellent.

Coloring Part Forming Step (1e)

Next, by drying the inks 2 that have been ejected into the cells 14, the liquid medium is evaporated or removed from the inks 2 in the cells 14 to thereby form coloring parts 12 of a solid state (1e). In this way, a color filter 1 can be obtained.

Further, in this step, the resin material may be reacted with any curing component or the like, if necessary. The removal of the liquid component can be carried out by heating the inks 2, for example. Such heating may be carried out in a state that the substrate 11 with the inks 2 is placed in an atmosphere of a reduced pressure.

This makes it possible to progress the removal of the liquid medium efficiently, while preventing occurrence of an adverse effect to the substrate 11 and the like. In addition, this step may be carried out under irradiation with radio rays. This makes it possible to progress the reaction of the resin material and the curing component efficiently.

In the color filter manufacturing process according to the present invention, a correction data producing step which produces correction data used in the ink supplying step is implemented prior to the ink supplying step (that is, before the color filter 1 is completed). This correction data producing step is implemented periodically, and the drawing pattern data is corrected with the produced correction data and the ink supplying step is carried out using the corrected drawing pattern data. In this regard, it is to be noted that the correction of the drawing pattern data may be implemented during the correction data producing step or after the correction data producing step.

In the correction data producing step, first, a test color filter is manufactured in the same manner as the color filter 1 described above. Namely, in the same manner as the ink supplying step described above, by using the droplet ejection apparatus 100 which is also used in the ink supplying step, inks 2 for a color filter 1 which are also used in the ink supplying step are supplied into cells 14 formed on the test substrate (which are the same as the cells 14 of the substrate 11).

Then, in the same manner as the coloring part forming step, the liquid medium is removed from the inks 2 in the cells 14 to thereby form coloring parts 12 in a solid state. In this way, a test substrate on which the coloring parts are formed, that is, a test color filter can be obtained. The constituent material and dimensions of the test substrate may be different from those of the substrate 11 for actual use, or may be the same as those of the substrate 11.

Next, an amount of the ink 2 in each of the cells 14 (e.g., volume and weight thereof) formed on the test substrate (test color filter) is detected. Hereinafter, the test substrate on which the cells 14 are formed is simply referred to as “test substrate” on occasions.

The defection of the amount of the ink 2 may be carried out by irradiating light having a predetermined wavelength to the test substrate and then measuring a quantity of reflective light (reflectance) or a quantity of transmitted light (transmittance), or other measures.

Specifically, first, an image of the test substrate is taken by the CCD camera 5. In this case, an image of the entire of the test substrate may be taken by one shot or by several shots, or with continuously scanning along a predetermined direction.

The image data taken by the CCD 5 is inputted into the control unit 112, and then stored in the storage unit 202. Thereafter, the image data is subjected to a predetermined imaging treatment by the control unit 112 to thereby obtain a quantity of light for each cell 14 of the test substrate.

On the other hand, a standard curve or a table that shows a relationship between a quantity of light for each cell 14 of the test substrate and an amount of the ink 2 in each cell 14 is in advance prepared by an experiment, and it is stored in the storage unit 202. The control unit 112 obtains the amount of the ink 2 in each cell 14 of the test substrate based on the quantity of light corresponding to each cell 14 of the test substrate using the standard curve or table.

In this connection, normally, there is a case that some cells 14 in the whole cells 14 of the test substrate contain an ink 2 of which amount is greater than a target amount (target value), and other some cells 14 in the whole cells 14 of the test substrate contain an ink 2 of which amount is smaller than the target amount.

Next, the control unit 112 produces based on the detection result correction data which is used for adjusting a number of droplets to be supplied into each cell 14 of the substrate 11 so that an amount of the ink 2 to be supplied to the cell 14 becomes the target amount.

Specifically, the control unit 112 compares an amount of the ink 2 in each cell 14 with the target amount for each of the whole cells 14 of the test substrate, and then obtains a difference (difference value) therebetween. The difference value is then converted into a number of droplets to be ejected from the nozzle 25. In this case, for each cell 14 to which the ink 2 of which amount is greater than the target amount has been supplied, the number of droplets to be supplied thereto is decreased based on the difference.

On the other hand, for each cell 14 to which the ink 2 of which amount is smaller than the target amount has been supplied, the number of the droplets to be supplied thereto is increased based on the difference. The correction data is produced so that the control unit 112 can perform the above processing. This correction data is then stored in the storage unit 202. In this regard, it is to be noted that in the case where the correction data has already been stored, the previous correction data is renewed (updated) with this new correction data.

Then, the drawing pattern data is corrected by the control unit 112 with the use of the correction data. In this way, for each cell 14 to which the ink 2 of which amount is greater than the target amount has been supplied, drawing patter data in which the number of droplets to be supplied thereto is decreased based on the difference can be obtained.

On the other hand, for each cell 14 to which the ink 2 of which amount is smaller than the target amount has been supplied, drawing pattern data in which the number of the droplets to be supplied thereto is increased based on the difference can be obtained. These corrected drawing pattern data are then stored in the storage unit 202. That is, the drawing pattern data stored in the storage unit 202 is updated with the corrected drawing pattern data.

In this way, during the period after correction data producing step has been implemented and before a next correction data producing step will be implemented, in the case where a color filter 1 is to be manufactured, such a color filter 1 is manufactured through the ink supplying step using the drawing pattern data which has been corrected by the correction data produced in this correction data producing step.

In this case, the correction data producing step is periodically implemented. For example, the correction data producing step may be implemented upon each predetermined time period, or at a time when a component of the droplet ejection apparatus 100 such as a head unit 103 (20) is periodically exchanged, and the like.

An amount of an ink 2 ejected from each of the nozzles 25 changes with the lapse of time. Further, it also changes when the head unit 103 is exchanged. Therefore, by correcting the drawing pattern data with the correction data, it is possible to prevent or suppress uneven color, uneven color density and color heterogeneity from being generated at various portions of a manufactured color filter 1.

Here, the term “correction of the data” includes the case where the previous drawing pattern data (drawing pattern data before the correction) is corrected with (synthesized by) the correction data as described above. In addition, the term “correction of the data” also includes the case where the ink supplying step is carried out using the previous drawing pattern data corrected with the correction data in which the previous drawing pattern data and the correction data are stored separately in a state that they are associated with each other.

Further, supply or ejection of the ink 2 into cells 14 of the substrate 11 base on the corrected data may be carried out at any point of time during the ink supplying step. For example, such supply or ejection of ink 2 may be carried out at the start of the ink supplying step, at the end of the ink supplying step or at the midway of the ink supplying step.

Furthermore, in the correction data producing step, when an image of the imaging of the test substrate is taken by the CCD camera 5 as described above, it may be carried out with a state that the ink 2 in the cells of the test substrate is in a liquid state (wetting state) by omitting the coloring part forming step.

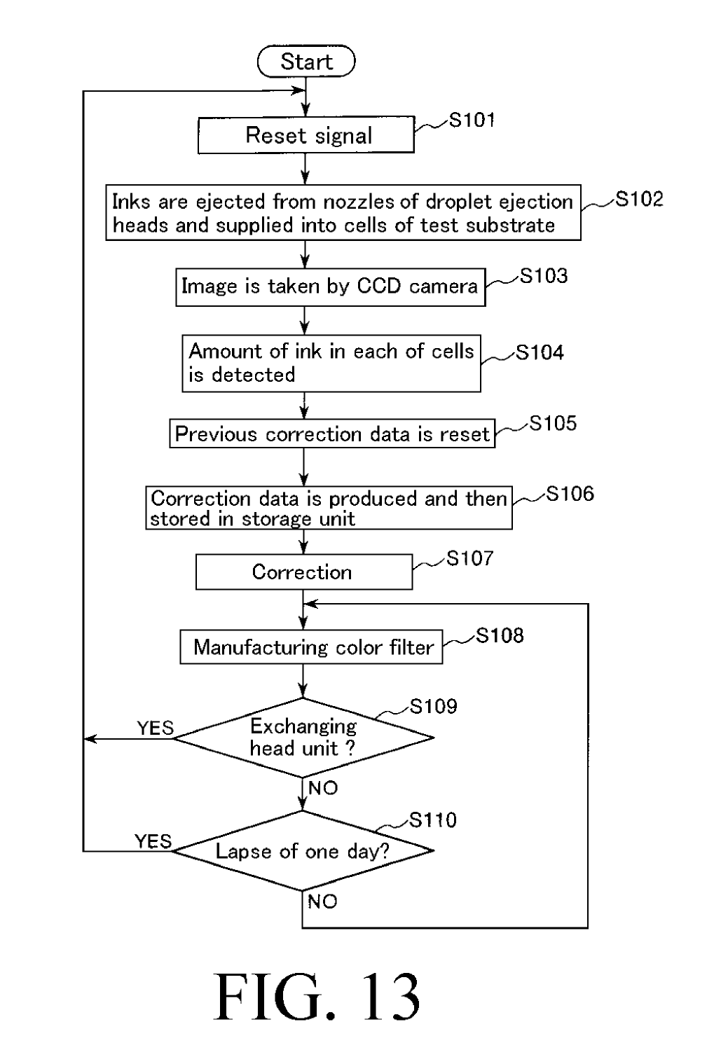

Next, based on FIG. 13, a description will be made in more detail with regard to a concrete example of the correction data producing step. In this example, the correction data producing step is implemented every morning (every day), and then a color filter 1 is manufactured using the corrected drawing pattern data.

Further, in this example, a head unit 103 is also exchanged for a new one periodically on the morning. FIG. 13 is a flow chart which shows control operations of an overall system including the droplet ejection apparatus 100 shown in FIG. 2.

As shown in FIG. 13, first, a reset signal is inputted (step S101). This reset signal may be inputted automatically or inputted by an operation of the operating section 4.

Next, the correction data producing step is started. Namely, based on the drawing pattern data used in the ink supplying step, the ink 2 is ejected from the nozzles 25 and supplied into the cells 14 of the test substrate (step S102).

Next, an image of the test substrate is taken by the CCD camera 5 to read out the image data thereof (step S103). Next, based on the image data, an amount of the ink 2 in each of the cells 14 of the test substrate is detected (Step S104). Next, the previous correction data stored in the storage unit 202 is reset (erased) (Step S105).

Next, based on the amounts of the inks 2 in the respective cells 14 of the test substrate which have been obtained in the Step S104, correction data is produced. This correction data is then stored in the storage unit (Step S106). In this way, the previous correction data stored in the storage unit 202 is updated (renewed) into the new correction data produced in this correction data producing step.

Next, the drawing pattern data is corrected with the updated correction data obtained in the Step S106, and then the corrected drawing pattern data is stored in the storage unit 202 (Step S107). In this way, the previous drawing pattern data stored in the storage unit 202 is updated (renewed) into this corrected drawing pattern data.

Next, the color filter manufacturing process is started, wherein color filters 1 are manufactured through the ink supplying step using the corrected drawing pattern data (Step S108).

Next, a determination is made on as to whether or not the head unit 103 is exchanged for a new one. In the case where it is determined that the head unit 103 has not yet been exchanged, a determination is made on as to whether or not one day has elapsed since the previous correction data producing step (Step S110). In the case where it is determined that one day has not yet been elapsed, the program returns to the Step S108, and then the steps subsequent to the Step S108 are executed again.

In this way, for a predetermined period of time, the ink supplying step is carried out using the corrected drawing pattern data which has been corrected with the new correction data which has been produced in this correction data producing step, that is, color filters 1 are manufactured using the corrected drawing pattern data.

On the other hand, in the case where it is determined that the head unit 103 has been exchanged for a new one, or in the case where it is determined that one day has already elapsed since the previous correction data producing step, the program returns to the Step S101, and the steps subsequent to the Step S101 are executed again.

Namely, as described above, a reset signal is inputted, and then a correction data producing step is implemented again to thereby produce new correction data. The previous correction data is updated by the new correction data, and the previous drawing pattern data is corrected and updated with the new correction data. In this way, a reset signal is periodically inputted and thereby the correction data producing step is also implemented at that timing periodically.

In this regard, it is to be noted that the Step S105 may be executed between the Step S101 and the Step S102. In other words, the previous correction data may be reset just after the input of the reset signal. As described above, according to the method of manufacturing a color filter 1 of this embodiment, it is possible to prevent or suppress uneven color, uneven color density and color heterogeneity from being generated at various portions of a manufactured color filter 1.

Further, it is possible to manufacture a color filter 1 having a required quality (high quality) with one drawing operation. Therefore, yielding of the products is improved. In addition, it is possible to reduce time and effort required for manufacturing a color filter 1 as compared to the conventional manufacturing method where data correction, drawing operation and inspection are carried out once after drawing operation and inspection have been carried out.

Furthermore, according to this embodiment, it is not necessary to produce correction data each time upon manufacturing a color filter 1. In this embodiment, once correction data is produced, it is possible to manufacture color filters 1 using the corrected drawing pattern data during a predetermined period of time. Therefore, the manufacturing method of the present invention is advantageous in massproduction of color filters 1.

In this regard, it is to be noted that in this embodiment all cells (entire surface) of the test substrate (base 11) are used for producing correction data in the correction data producing step. However, according to the present invention, a part of the cells may be used for producing correction data. Namely, among cells for red, cells for green and cells for blue, cells for a specified one color or cells for specified two colors may be used for producing the correction data in the correction data producing step.

Further, cells located in a region of a color filter 1 where uneven color, uneven color density and color heterogeneity are likely to be generated may be used for producing correction data in the correction data producing step.

### Second Embodiment

Hereinbelow, a description will be made with regard to a second embodiment. In this regard, it is to be noted that the description is made by focusing different points from the first embodiment, and the description for the common points with the first embodiment is omitted. The second embodiment is common with the first embodiment except for the correction data producing step.

In this correction data producing step of the second embodiment, first, an amount of an ink 2 ejected from each nozzle 25 per one ejecting operation is detected.

This detection is carried out, for example, by ejecting a droplet of the ink 2 from the nozzle 25 onto a glass substrate with one ejection operation and then measuring a volume of the one droplet of the ink 2 on the glass substrate by an optical method. Alternatively, the detection may be carried out by applying a droplet of the ink 2 onto a roll paper and then taking an image of the droplet of the ink 2 by a CCD camera 5 to measure a volume of the droplet of the ink 2 based on the image thereof.

Then, based on the detection result and the drawing pattern data, the control unit 112 estimates (supposes) an amount of the ink 2 to be supplied to each cell 14 in the case where the droplets of the ink 2 are ejected from the nozzles 25 of the droplet ejection head 20 to supply the ink 2 into the cells 14 of the substrate 11. That is to say, the quality of a color filter 1 to be manufactured is estimated.

Next, in the same manner as the first embodiment, based on the estimated result of the amount of the ink 2 to be supplied into each of the cells 14, the control unit 112 produces correction data which is used for adjusting the number of droplets of the ink 2 to be supplied into each of the cells 14 becomes a target amount, and then corrects the drawing pattern data with the correction data.

Then, the ink supplying step is carried out using the corrected drawing pattern data to thereby manufacture color filters 1. According to the second embodiment, it is possible to obtain the same results as those of the first embodiment.

### Third Embodiment

Hereinbelow, a description will be made with regard to a third embodiment. In this regard, it is to be noted that the description is made by focusing different points from the first embodiment, and the description for the common points with the first embodiment is omitted. The third embodiment is common with the first embodiment except for further providing a driving voltage adjusting step.

In this third embodiment, prior to the correction data producing step, a driving voltage adjusting step which adjusts a driving voltage to be applied across the pair of the electrodes 124A and 124B (that is, to the piezo electric element (driving element) 124C) is carried out.

In this driving voltage adjusting step of the third embodiment, first, an amount of an ink 2 ejected from each nozzle 25 per one ejecting operation is detected.

This detection is carried out, for example, by ejecting a droplet of the ink 2 from the nozzle 25 onto a glass substrate with one ejection operation and then measuring a volume of the one droplet of the ink 2 on the glass substrate by an optical method. Alternatively, the detection may be carried out by applying a droplet of the ink 2 onto a roll paper and then taking an image of the droplet of the ink 2 by a CCD camera 5 to measure a volume of the droplet of the ink 2 based on the image thereof.

Next, based on the detection result, a driving voltage applied to the piezo electric element 124C is adjusted so that variations in the amounts of the inks ejected from the respective nozzles 25 become smaller (as smaller as possible). As a method for adjusting the driving voltage applied to the piezo electric element 124C, it is possible to mention a method in which a voltage of the driving voltage is changed, for example. According to the third embodiment, it is possible to obtain the same results as those of the first embodiment.

Further, in this third embodiment, since the driving voltage adjusting step is carried out prior to the correction data producing step, it is possible to prevent or suppress uneven color, uneven color density and color heterogeneity from being generated at various portion of a manufactured color filter 1. In this regard, it is to be noted that this third embodiment can be additionally applied to the second embodiment.

Image Display Device

Next, a description will be made with regard to a preferred embodiment of a liquid crystal display device which is one example of an image display device (electro-optic apparatus) provided with the color filter 1 of the present invention.

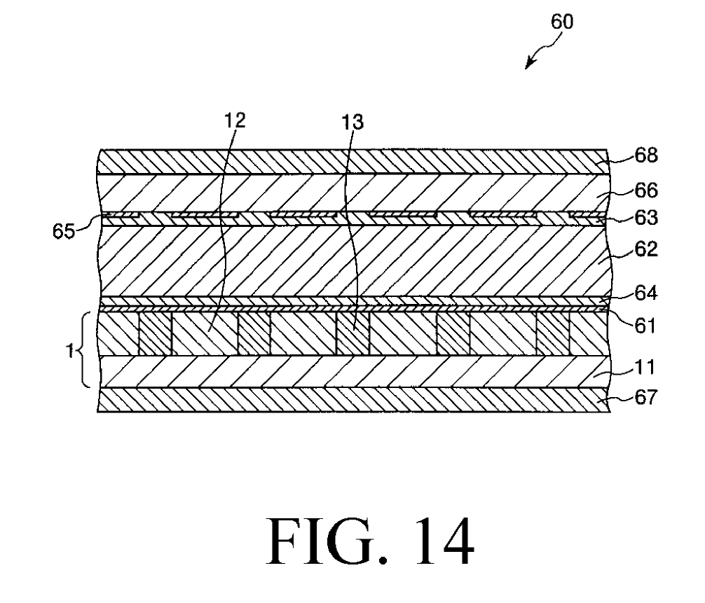

FIG. 14 is a cross-sectional view which shows a preferred embodiment of the image display device. As shown in this figure, the liquid crystal display device 60 includes the color filter 1, a substrate (opposed substrate) 66 which is provided on the side of the color filter 1 on which the coloring parts 12 are formed, a liquid crystal layer 62 which contains a liquid crystal filled in a space between the color filter 1 and the substrate 66, a polarizing plate 67 provided on a surface of the substrate 11 of the color filter 1 which does not face the liquid crystal layer 62, and a polarizing plate 68 provided on a surface of the substrate 66 which does not face the liquid crystal layer 62.

Further, a common electrode 61 is provided on the coloring parts 12 and the partitioning walls 13 of the color filter 1, and pixel electrodes 65 are provided on a surface of the substrate 66 that faces the liquid crystal layer 62 in a matrix manner. In addition, an orientation film 64 is provided between the common electrode 61 and the liquid crystal layer 62, and an orientation film 63 is provided between the substrate 66 (including the pixel electrodes 65) and the liquid crystal layer 62.

The substrate 66 has a light transmitting property for visible light, and it is formed from a glass substrate, for example. The common electrode 61 and the pixel electrodes 65 are also formed of a constituent material having a light transmitting property for visible light, and they may be formed of ITO or the like, for example.

Further, though not shown in this figure, a number of switching elements (e.g. TFTs, that is, thin film transistors) are provided so as to correspond to the respective pixel electrodes 65. With this structure, by controlling a voltage applying state between the common electrode 61 and the respective pixel electrodes 65 that correspond to the respective coloring parts 12, it is possible to control light transmitting properties of lights through regions corresponding to the respective coloring parts 12 (respective pixel electrodes 65).

In the liquid crystal display device 60, light emitted from a back light not shown in this figure is incident on the device 60 from the side of the polarizing plate 68 (from the upper side in FIG. 14). The light that has passed through the liquid crystal layer 62 and then entered into the respective coloring parts 12 (coloring parts 12A, coloring parts 12B, coloring parts 12C) of the color filter 1 is emitted from the side of the polarizing plate 67 as lights having different colors corresponding to the colors of the respective coloring parts 12 (coloring parts 12A, coloring parts 12B, coloring parts 12C).

As described above, the coloring parts 12 are formed using the inks 2 for a color filter of the present invention, variations in the properties among the respective colors and the respective pixels are preferably suppressed. As a result, the liquid crystal apparatus 60 can display images having less uneven color and uneven density stably.

Electronic Apparatus

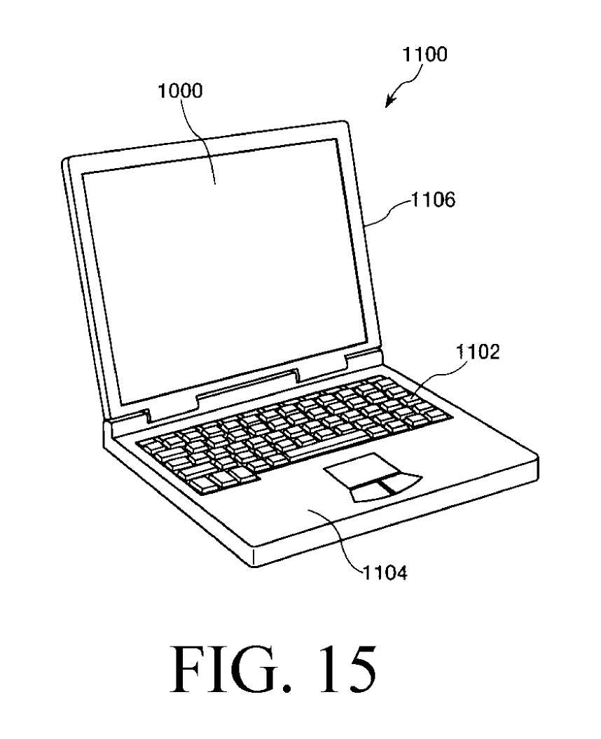

The image display device (electro-optical device) 1000 provided with the color filter 1 of the present invention can be applied to image display portions of various electronic apparatuses. FIG. 15 is a perspective view which shows a structure of a personal computer of a mobile type (or a notebook type) which is one example of the electronic apparatus of the present invention.

In this figure, a personal computer 1100 is comprised of a main body 1104 provided with a keyboard 1102 and a display unit 1106 provided with a display. The display unit 1106 is rotatably supported by the main body 1104 via a hinge structure. In the personal computer 1100, for example, the display unit 1106 includes the image display device 1000 described above.

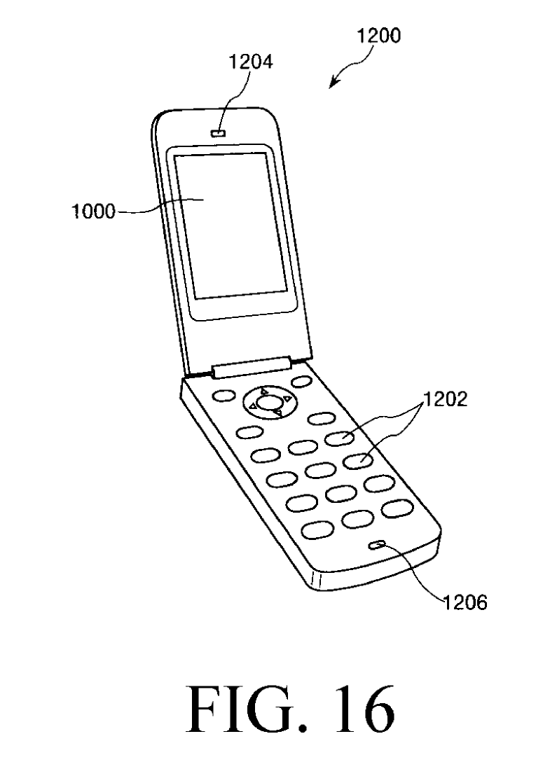

FIG. 16 is a perspective view which shows the structure of a mobile (portable) phone (including the personal handy phone system (PHS)) which is another example of the electronic apparatus according to the present invention. The mobile phone 1200 shown in this figure includes a plurality of operation buttons 1202, an earpiece 1204, a mouthpiece 1206, and a display unit 1106 comprised of the image display device 1000.

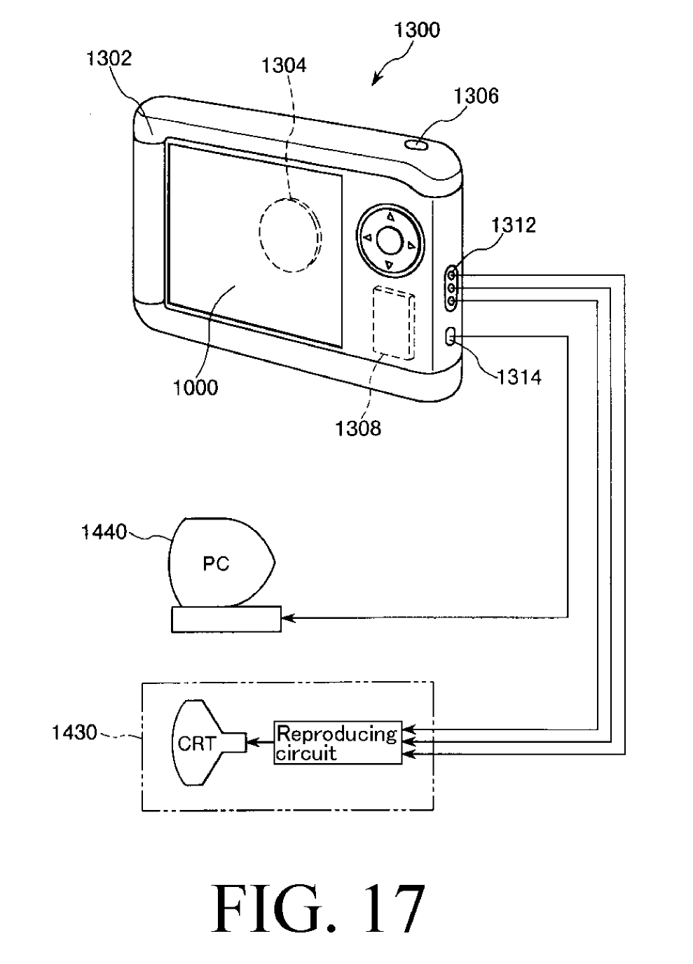

FIG. 17 is a perspective view which shows a structure of a digital still camera which is other example of the electronic apparatus according to the present invention. In this drawing, interfacing to external devices is simply illustrated.

In a conventional camera, a silver salt film is exposed to the optical image of an object. On the other hand, in the digital still camera 1300, an image pickup device such as a CCD (Charge Coupled Device) generates an image pickup signal (or an image signal) by photoelectric conversion of the optical image of an object.

In the rear surface of a case (or a body) 1302 of the digital still camera 1300, there is provided a display comprised of the image display device 1000 which provides an image based on the image pickup signal generated by the CCD. That is, the display functions as a finder which displays the object as an electronic image.

In the inside of the case 1302, there is provided a circuit board 1308. The circuit board 1308 has a memory capable of storing an image pickup signal. In the front surface of the case 1302 (in FIG. 17, the front surface of the case 1302 is on the back side), there is provided a light receiving unit 1304 including an optical lens (an image pickup optical system) and a CCD.

When a photographer presses a shutter button 1306 after checking an object image on the display, an image pickup signal generated by the CCD at that time is transferred to the memory in the circuit board 1308 and then stored therein.

Further, in the side surface of the case 1302 of the digital still camera 1300, there are provided a video signal output terminal 1312 and an input-output terminal for data communication 1314. As shown in FIG. 17, when necessary, a television monitor 1430 and a personal computer 1440 are connected to the video signal output terminal 1312 and the input-output terminal for data communication 1314, respectively. In this case, an image pickup signal stored in the memory of the circuit board 1308 is outputted to the television monitor 1430 or the personal computer 1440 by carrying out predetermined operations.

Examples of the electronic apparatus according to the present invention may include, in addition to the personal computer (which is a personal mobile computer), the mobile phone, and the digital still camera described above with reference to FIG. 15 to FIG. 17, a television (TV) set (television with a liquid crystal display), a video camera, a view-finer or monitor type of video tape recorder, a laptop-type personal computer, a car navigation device, a pager, an electronic notepad (which may have communication facility), an electronic dictionary, an electronic calculator, a computerized game machine, a word processor, a workstation, a videophone, a security television monitor, an electronic binocular, a POS terminal, an apparatus provided with a touch panel (e.g., a cash dispenser located on a financial institute, a ticket vending machine), medical equipment (e.g., an electronic thermometer, a sphygmomanometer, a blood glucose meter, an electrocardiograph monitor, ultrasonic diagnostic equipment, an endoscope monitor), a fish detector, various measuring instruments, gages (e.g., gages for vehicles, aircraft, and boats and ships), a flight simulator, various monitors, a projection display such as a projector, and the like.

Among these electronic apparatuses mentioned above, a display size of TVs tends to be enlarged, and this tendency becomes more conspicuously in recent years. In electronic apparatuses having such a large size display (e.g., monitor or screen having a diagonal size of 80 cm or more), in the case where a color filter 1 manufactured using the conventional manufacturing method is employed, there is a problem in that uneven color and uneven density are highly likely to occur.

However, by applying the present invention to such a color filter 1 for a large size display, such a problem as described above can be prevented reliably. In other words, when the present invention is applied to electronic apparatuses having such a large size display, the effects of the present invention are exhibited more conspicuously.

In the foregoing, the present invention was described based on the preferred embodiments thereof, but the present invention is not limited thereto. Furthermore, any parts or components of the color filter 1, the image display device and the electronic apparatus described above may be replaced with other parts or components that can exhibit the same or similar functions, and other additional parts or components may be added thereto.

For example, in the embodiments described above, after the inks 2 corresponding to the respective coloring parts 12 are supplied into the cells 14, the liquid medium is removed from the inks 2 in the cells 14 at once. That is, in the embodiments described above, the coloring part forming step is carried out just one time. However, the coloring part forming step may be carried out repeatedly for each of the inks 2 of the different colors of the respective coloring parts 12.

Further, in the color filter 1 of the present invention, a protective film may be provided on the coloring parts 12 formed on the substrate 11. This makes it possible to effectively prevent the coloring parts 12 and other portions from being damaged or deteriorated.

1. A method of manufacturing a color filter using a droplet ejection apparatus having droplet ejection heads each having a plurality of nozzles from which droplets of inks having different colors are ejected into cells formed on a substrate for a color filter to be manufactured by an ink jet method, the method including an ink supplying step in which each of the inks is supplied to a plurality of corresponding cells in the cells on the substrate from the nozzles of each droplet ejection head based on drawing pattern data, the method comprising:
correction data producing step which is comprised of:
preparing a test substrate having cells which correspond to the respective cells of the substrate;
supplying the ink into predetermined cells of the test substrate based on the drawing pattern data by supplying the droplets of the ink to the predetermined cells from the nozzles of the droplet ejection head using the ink jet method; and
detecting an amount of the ink supplied to each of the predetermined cells of the test substrate;
wherein the correction data is used in adjusting a number of droplets of the ink to be supplied to each cell of the substrate based on the detection result so that an amount of the ink to be supplied to the cell becomes a target amount,
wherein the correction data producing step is periodically carried out for correcting the drawing pattern data, and the ink supplying step for supplying each of the inks to the corresponding cells on the substrate is then carried out using the corrected drawing pattern data to thereby manufacture the color filter.

2. A method of manufacturing a color filter using a droplet ejection apparatus having droplet ejection heads each having a plurality of nozzles from which droplets of inks having different colors are ejected into cells formed on a substrate for a color filter to be manufactured by an ink jet method, the method including an ink supplying step in which each of the inks is supplied to a plurality of corresponding cells in the cells on the substrate from the nozzles of each droplet ejection head based on drawing pattern data, the method comprising:
correction data producing step which is comprised of:
detecting an amount of the ink ejected from each nozzle per one ejecting operation; and
estimating an amount of the ink to be supplied to each cell when the ink is supplied to the cell of the substrate by ejecting the droplets of the ink from the nozzles of the droplet ejection head by the ink jet method based on the detection result and the drawing pattern data;
wherein the correction data is used in adjusting a number of droplets of the ink to be supplied to each cell of the substrate based on the result of the estimation so that an amount of the ink to be supplied to the cell becomes a target amount,
wherein the correction data producing step is periodically carried out for correcting the drawing pattern data, and the ink supply step for supplying each of the inks to the corresponding cells on the substrate is then carried out using the corrected drawing pattern data to thereby manufacture the color filter.

3. The method of manufacturing a color filter as claimed in claim 1, wherein the predetermined cells include all of the cells, cells for a specified one color or specified more colors, or cells for a specified region.

4. The method of manufacturing a color filter as claimed in claim 1, wherein the droplet ejection heads are periodically exchanged, and the correction data producing step is carried out at a time when the droplet ejection heads are exchanged.

5. The method of manufacturing a color filter as claimed in claim 1, wherein a reset signal is periodically inputted into the droplet ejection apparatus, and the correction data is updated into new correction data each time upon the input of the reset signal.

6. The method of manufacturing a color filter as claimed in claim 1, wherein the correction of the drawing pattern data is carried out during the correction data producing step or after the correction data producing step.

7. The method of manufacturing a color filter as claimed in claim 1, wherein each of the droplet ejection heads includes driving elements, and each droplet ejection head is constructed so that the droplets of the ink are ejected from each nozzle of the droplet ejection heads when a driving voltage is applied to each driving element, wherein the method further comprises a driving voltage adjustment step which includes a step of detecting an amount of the ink ejected from each nozzle per one ejecting operation prior to the correction data producing step and a step of adjusting the driving voltage to be applied to each driving element based on the detection result so that variations of the amount of the ink ejected from each nozzle per one ejecting operation are made to be small.

8. A color filter manufactured by the color filter manufacturing method defined in claim 1.

9. An image display device provided with the color filter defined in claim 8.

10. The image display device as claimed in claim 9, wherein the image display device is a liquid crystal panel.

11. An electronic apparatus provided with the image display device defined in claim 9.

12. The method of manufacturing a color filter as claimed in claim 2, wherein the predetermined cells include all of the cells, cells for a specified one color or specified more colors, or cells for a specified region.

13. The method of manufacturing a color filter as claimed in claim 2, wherein the droplet ejection heads are periodically exchanged, and the correction data producing step is carried out at a time when the droplet ejection heads are exchanged.

14. The method of manufacturing a color filter as claimed in claim 2, wherein a reset signal is periodically inputted into the droplet ejection apparatus, and the correction data is updated into new correction data each time upon the input of the reset signal.

15. The method of manufacturing a color filter as claimed in claim 2, wherein a reset signal is periodically inputted into the droplet ejection apparatus, and the correction data is updated into new correction data each time upon the input of the reset signal.

16. The method of manufacturing a color filter as claimed in claim 2, wherein each of the droplet ejection heads includes driving elements, and each droplet ejection head is constructed so that the droplets of the ink are ejected from each nozzle of the droplet ejection heads when a driving voltage is applied to each driving element, wherein the method further comprises a driving voltage adjustment step which includes a step of detecting an amount of the ink ejected from each nozzle per one ejecting operation prior to the correction data producing step and a step of adjusting the driving voltage to be applied to each driving element based on the detection result so that variations of the amount of the ink ejected from each nozzle per one ejecting operation are made to be small.

17. The method of manufacturing a color filter as claimed in claim 2, wherein each of the droplet ejection heads includes driving elements, and each droplet ejection head is constructed so that the droplets of the ink are ejected from each nozzle of the droplet ejection heads when a driving voltage is applied to each driving element, wherein the method further comprises a driving voltage adjustment step which includes a step of detecting an amount of the ink ejected from each nozzle per one ejecting operation prior to the correction data producing step and a step of adjusting the driving voltage to be applied to each driving element based on the detection result so that variations of the amount of the ink ejected from each nozzle per one ejecting operation are made to be small.

18. An image display device provided with the color filter defined in claim 17.

19. The image display device as claimed in claim 18, wherein the image display device is a liquid crystal panel.

20. The image display device as claimed in claim 18, wherein the image display device is a liquid crystal panel.
